(19) United States
(12) Patent Application Publication
(10) Pub. No.: US 2013/0317802 A1
(43) Pub. Date: Nov. 28, 2013

(54) METHOD FOR SIMULATING DATA TRANSMISSION AMONG A PLURALITY OF HARDWARE ELEMENTS

(71) Applicant: FUJITSU LIMITED, Kawasaki-shi (JP)

(72) Inventors: Manabu YAMAZAKI, Fuchu (JP); Noriyasu NAKAYAMA, Shinagawa (JP); Koji MIGITA, Kawasaki (JP); Kazuhiko HATAE, Kawasaki (JP); Naoto SHIMOJI, Kawasaki (JP); Yasuo OHTOMO, Yokohama (JP)

(73) Assignee: FUJITSU LIMITED, Kawasaki-shi (JP)

(21) Appl. No.: 13/898,979

(22) Filed: May 21, 2013

(30) Foreign Application Priority Data
May 25, 2012 (JP) 2012-120285
Jan. 22, 2013 (JP) 2013-009672

(51) Int. Cl. G06F 17/50

(52) U.S. Cl. CPC G06F 17/5036
USPC 703/14

(57) ABSTRACT

An event-driven simulation is performed on an operation of data transmission from a source hardware element to a destination hardware element. Upon receiving a first request for transmitting first data at a first time-point, data stored in a storage area of the destination hardware element is saved as backup data in a memory, and the first data is stored in the storage area. A first time-period for transmitting the first data is measured from the first time-point. When a second request having a higher priority than the first request is received at a second time-point, a portion of the backup data is restored to the storage area so that the storage area stores third data estimated to have been transmitted to the destination hardware element. After a second time-period for the second request is measured, the first data is again stored in the storage area.

### CROSS-REFERENCE TO RELATED APPLICATIONS

This application is based upon and claims the benefit of priority of the prior Japanese Patent Application No. 2012-120285, filed on May 25, 2012, and the Japanese Patent Application No. 2013-009672, filed on Jan. 22, 2013, the entire contents of which are incorporated herein by reference.

### FIELD

The embodiments discussed herein are related to a method for simulating data transmission among a plurality of hardware elements.

### BACKGROUND

Traditionally, regarding transmission of data between a plurality of hardware elements in a system that has the hardware elements and a bus connecting the hardware elements to each other, a technique is known in which permission is given, in order of priorities, to requests for permitting transmission of data when the requests for permitting the transmission are simultaneously generated by the plurality of hardware elements (refer to, for example, Japanese Laid-open Patent Publication No. 6-60017). In addition, a technique is known in which acceptance of a transmission request is switched among a plurality of transmission requests on the basis of a timer in order to inhibit a bus from being occupied for a long time by a transmission request issued by hardware with a high priority (refer to, for example, Japanese Laid-open Patent Publication No. 2002-55945).

An operation of firmware that is executed on the system is tested by electronic system level (ESL) simulation. Examples of the ESL simulation include an event-driven ESL simulation in which operations are executed on a command basis and a clock-based ESL simulation in which operations are executed on a clock basis. The event-driven ESL simulation may conduct a test at a higher speed than the clock-based ESL simulation.

### SUMMARY

According to an aspect of the embodiments, there is provided a simulation method performed by a computer that executes event-driven simulation on an operation of a system including a plurality of hardware elements and an arbitrating circuit for arbitrating transmission of data among the plurality of hardware elements. The computer simulates a reception operation of the arbitrating circuit receiving a first request for permitting transmission of first data from a source hardware element to a destination hardware element, the source and destination hardware elements being included in the plurality of hardware elements, and saves, in a memory, as backup data, data that has been stored in a storage area of the destination hardware element by the event-driven simulation. The computer performs a first storing operation of storing the first data in the storage area of the destination hardware element in accordance with the first request, and starts measurement of a first time-period taken to transmit the first data from the source hardware element to the destination hardware element in the system, from a first time-point at which the first data has been stored in the storage area of the destination hardware element. Upon receiving a second request for permitting transmission of second data at a second time-point after receiving the first request, the computer determines whether or not the second request has a higher priority than the first request. When it is determined that the second request has a higher priority than the first request, the computer restores, from the memory to the storage area of the destination hardware element, a portion of the backup data that is determined based on a second time-period between the first and second time-points so that the storage area stores, out of the first data, third data that is estimated to have been transmitted to the destination hardware element at the second time-point. The computer measures, from the second time-point, a second time-period taken to transmit the second data for the second request, and performs a second storing operation of storing again the first data in the storage area of the destination hardware element for the first request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of transition of change in an amount of transmission data, according to a first embodiment;

FIG. 2 is a diagram illustrating an example of a hardware configuration of a simulation device, according to an embodiment;

FIG. 3 is a diagram illustrating an example of a system to be simulated, according to an embodiment;

FIG. 4 is a diagram illustrating an example of a delay (DLY) register, according to a first embodiment;

FIG. 5 is a diagram illustrating an example of a margin table, according to a first embodiment;

FIG. 6 is a diagram illustrating an example of a functional configuration of a simulation device, according to a first embodiment;

FIGS. 7A and 7B are diagrams illustrating an example of an operational sequence for event control, according to a first embodiment;

FIGS. 7C to 7D are diagrams illustrating an example of an operational sequence for event control, according to a first embodiment.

FIGS. 8 and 9 are diagrams illustrating an example of an operational flowchart performed by a source hardware element, according to a first embodiment;

FIG. 10 is a diagram illustrating an example of an operational flowchart performed by a bus, according to a first embodiment;

FIG. 11 is a diagram illustrating an example of a hardware operation, according to a second embodiment;

FIG. 12 is a diagram illustrating an example of a functional configuration of a simulation device, according to a second embodiment;

FIG. 13 is a diagram illustrating an example of a first operation, according to a second embodiment;

FIG. 14 is a diagram illustrating an example of collection data, according to a second embodiment;

FIG. 15 is a diagram illustrating an example of generation of an expected value, according to a second embodiment;

FIG. 16 is a diagram illustrating an example of a second operation, according to a second embodiment;

FIG. 17 is a diagram illustrating an example of results of comparison of simulation results with expected values upon generation of a read request, according to a second embodiment;

FIG. 18 is a diagram illustrating an example of an operational flowchart performed by a simulation device, according to a second embodiment; and

FIG. 19 is a diagram illustrating an example of an operation based on another model.

### DESCRIPTION OF EMBODIMENTS

Operations of transmitting and receiving data between hardware elements in the event-driven ESL simulation, however, are different from actual hardware operations. Thus, a result of the event-driven ESL simulation may be different from a result of the actual hardware operations. For example, in the case of actual hardware operations, during transmission of data for a transmission event from a source hardware element to a destination hardware element, when another transmission event having a higher priority than the transmission event is generated, the transmission of data for the transmission event is suspended.

In the case of event-driven ESL simulation, when a transmission event is generated, data that is to be transmitted from a source hardware element is immediately stored in a storage area of a destination hardware element. In the event-driven ESL simulation, a timer measures a time-period taken to transmit the data. After the time-period taken to transmit the data is measured by the timer, the transmission event is completed. Thus, in the event-driven ESL simulation, even when another transmission event that has a higher priority than the transmission event is generated during the measurement of a time-period taken to transmit data for the certain transmission event, suspension of the transmission is not simulated. Thus, a result of the event-driven ESL simulation may be different from a result of the actual hardware operation.

Hereinafter, first and second embodiments of a simulation method will be described in detail with reference to the accompanying drawings.

### First Embodiment

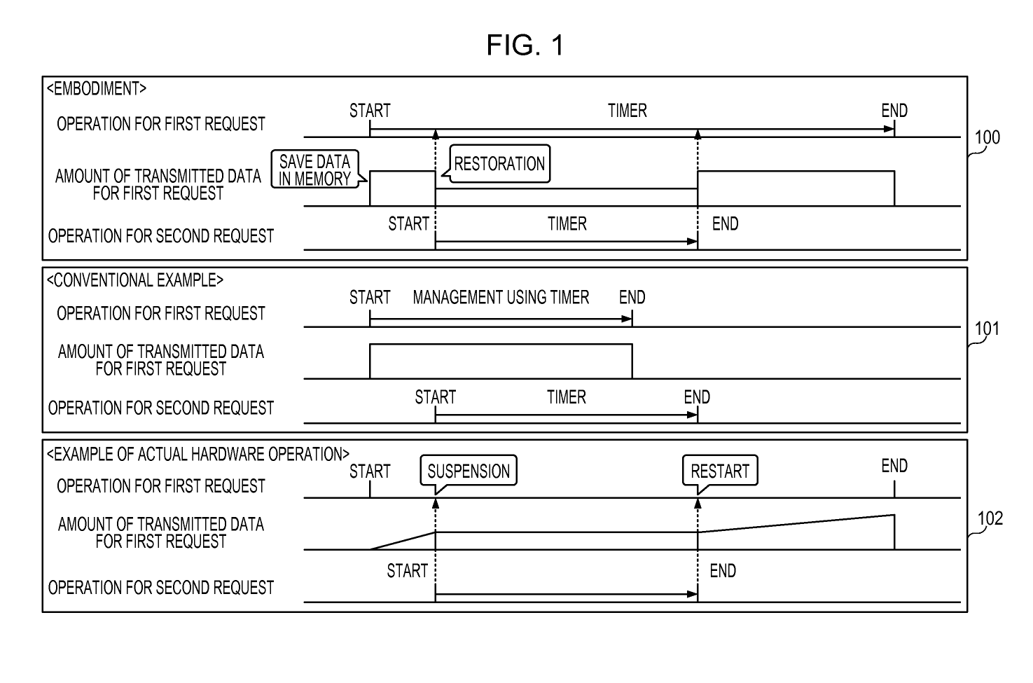

FIG. 1 is a diagram illustrating an example of transition of change in an amount of transmission data, according to a first embodiment. Before event-driven ESL simulation 100 is described, an example of an actual hardware operation 102 and an example of conventional event-driven ESL simulation 101 are described in order to facilitate understanding.

In the example of the actual hardware operation (hereinafter referred to as “hardware operation”) 102, when data transmission for a first request for permitting transmission of first data is started, a predetermined amount of data within of the whole transmission data is transmitted in accordance with a clock. In the hardware operation 102, when a second request for permitting transmission of second data, which has a priority higher than the first request, is generated during the data transmission for the first request, the data transmission for the first request is suspended. In the hardware operation 102, when data transmission for the second request is completed, the data transmission for the first request is restarted.

In the conventional event-driven ESL simulation (hereinafter abbreviated as “conventional simulation”) 101, when a first request for permitting transmission of first data from a source hardware element to a destination hardware element among a plurality of hardware elements is generated, the first data is immediately stored in a storage area of the destination hardware element. In the conventional simulation 101, a timer measures a time-period taken to transmit the first data from the source hardware element to the destination hardware element in a system, from a time-point at which the first data is stored in the storage area of the destination hardware element, and the amount of transmitted data at the time-period, where “transmitted data” means data that has been transmitted to the destination hardware element at the time-period, is assumed to be the amount of the whole first data.

In the conventional simulation 101, even when a second request for permitting transmission of second data, which has a priority higher than the first request, is generated during the measurement of a time-period for the first request, the amount of transmitted data for the first request is not changed during the measurement of a time-period for the first request.

In the conventional simulation 101, a time-period for suspension is not simulated unlike the hardware operation 102. Thus, in the conventional simulation 101, when another process that uses the data within the same time-period as a time-period for the suspension in the hardware operation 102 is generated, the data does not match between the conventional simulation 101 and the actual hardware operation 102. Thus, since an operation of transmitting and receiving data between hardware elements in the conventional event-driven ESL simulation 101 is different from the actual hardware operation 102, a result of the conventional event-driven ESL simulation 101 may be different from a result of the actual hardware operation 102.

In the event-driven ESL simulation 100 (hereinafter abbreviated as “simulation 100”) according to a first embodiment, when a first request for permitting transmission of first data from a source hardware element to a destination hardware element among a plurality of hardware elements is generated, data that has been stored, by the simulation, in a storage area of the destination hardware element is saved, as backup data, in a memory. Here, the memory is not a hardware element used for the simulation but is a memory device that is accessible by a simulation device executing the simulation 100. In the simulation 100 according to the first embodiment, the whole first data is stored, as transmitted data, in the storage area of the destination hardware element for the first request. In the simulation 100, a timer measures a time-period taken to transmit the first data from the source hardware element to the destination hardware element in a system, from a time-point at which the first data is stored in the storage area of the destination hardware element.

In the simulation 100, when a second request for permitting transmission of second data, having a higher priority than the first request, is generated during the measurement of a time-period for the first request, a portion of the storage area of the destination hardware element for the first request is restored to a state before the generation of the first request. In other words, data other than third data included in the backup data saved in the memory is restored to the storage area, where the third data is data included in the first data and estimated to have been transmitted by the actual hardware element up to the time-point of the generation of the second request. The data other than the third data, which is saved in the memory, may be extracted from the backup data in the memory based on a time-period that has elapsed from a first time-point at which the first data was stored, as transmitted data, in the storage area of the destination hardware element for the first request and a time-period taken to transmit the first data. Thus, in the simulation 100, when the second request having a higher priority than the first request is generated, the amount of transmitted data for the first request is reduced.

In the simulation 100, data that has been stored in a storage area of a destination hardware element for the second request is saved, as backup data, in a memory. In the simulation 100, the second data is stored in the storage area of the destination hardware element for the second request. In the simulation 100, starting from a time-point at which the second data was stored in the storage area of the destination hardware element for the second request, a timer measures a time-period taken to transmit the second data from the source hardware element to the destination hardware element for the second request in the system. In the simulation 100, the measurement of a time-period for the first request is suspended during the measurement of a time-period for the second request.

In the simulation 100, after the measurement of a time-period for the second request is completed, the first data for the first request is stored again in the storage area of the destination hardware element for the first request, and the suspended measurement of a time-period for the first request is restarted.

Thus, in the simulation 100, a time-period for the suspension is properly simulated. Therefore, in the simulation 100, even when another process uses data stored in the storage area during the same time-period as the time-period suspended in the hardware operation 102, the used data matches between the simulation 100 and the actual hardware operation 102. Thus, a simulation result that is close to a result of the actual hardware operation 102 may be obtained by the simulation 100.

Example of Hardware Configuration of Simulation Device

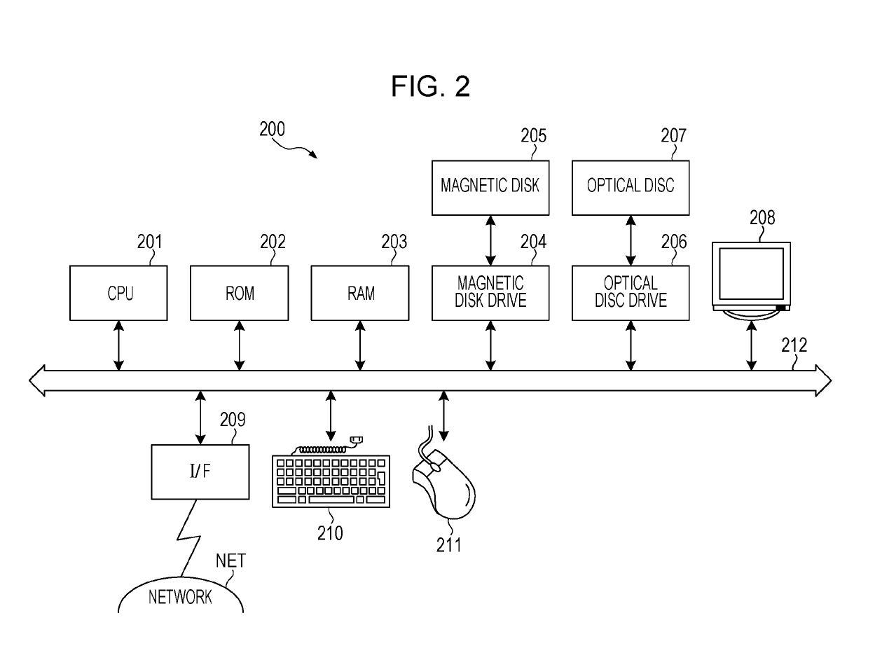

FIG. 2 is a diagram illustrating an example of a hardware configuration of a simulation device, according to an embodiment. A simulation device 200 illustrated in FIG. 2 includes a central processing unit (CPU) 201, a read-only memory (ROM) 202, and a random access memory (RAM) 203. The simulation device 200 includes a magnetic disk drive 204, a magnetic disk 205, an optical disc drive 206, an optical disc 207, a display 208, an interface (I/F) 209, a keyboard 210, and a mouse 211. The parts 201 to 204, 206, and 208 to 211 are connected to each other via a bus 212.

The CPU 201 controls the overall simulation device 200. The ROM 202 stores programs such as a boot program. The RAM 203 is used as a work area of the CPU 201. The magnetic disk drive 204 controls reading and writing of data from and in the magnetic disk 205 in accordance with control executed by the CPU 201. The magnetic disk 205 stores data written in accordance with control executed by the magnetic disk drive 204.

The optical disc drive 206 controls reading and writing of data from and in the optical disc 207 in accordance with control executed by the CPU 201. The optical disc 207 stores data written in accordance with control executed by the optical disc drive 206. The optical disc drive 206 causes the data stored in the optical disc 207 to be read by a computer.

The display 208 displays data, such as a cursor, an icon, a toolbox, a document, an image, and function information. As the display 208, a CRT, a TFT liquid crystal display, a plasma display, or the like may be used.

The I/F 209 is connected through a communication line to a network NET such as a local area network (LAN), a wide area network (WAN), or the Internet. The I/F 209 is connected through the network NET to another device. The I/F 209 serves as an internal interface with the network NET and controls input and output of data to and from an external device. As the I/F 209, a modem, a LAN adapter, or the like may be used.

The keyboard 210 has keys for inputting data such as characters, numbers, and various instructions, so as to enter the data. Instead of the keyboard 210, a touch panel type input pad, a numerical keypad or the like may be used. The mouse 211, for example, moves the cursor, selects a range, moves a window, and changes a size. A trackball, a joystick or the like may be used instead of the mouse 211 as long as the trackball, the joystick or the like has the same function as the mouse 211 as a pointing device.

Example of System

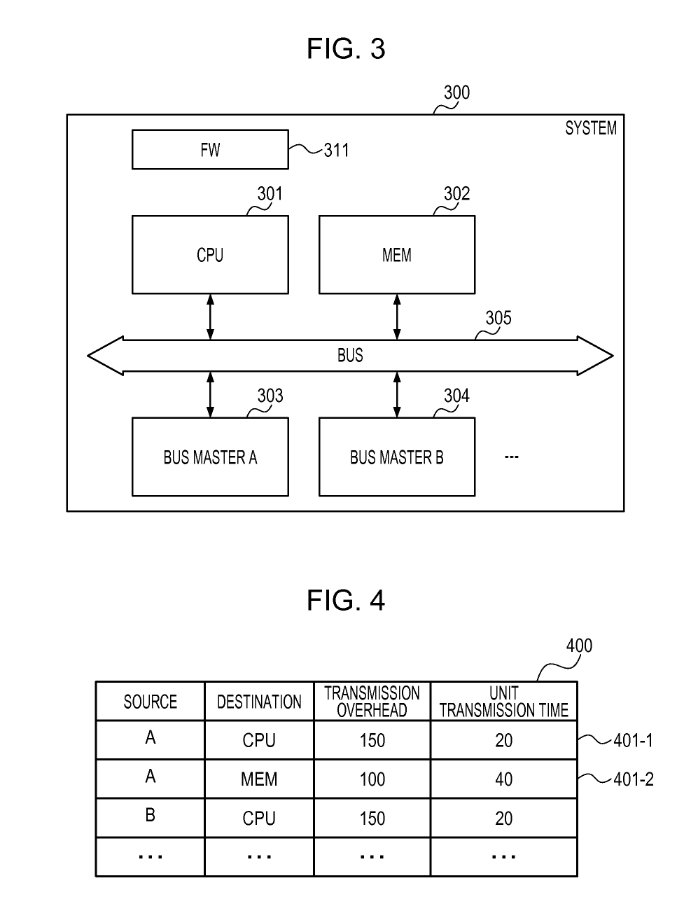

FIG. 3 is a diagram illustrating an example of a system to be simulated, according to a first embodiment. In the first embodiment, a system 300 to be simulated includes a CPU 301, an MEM 302, a bus master A 303, a bus master B 304, and a bus 305. The CPU 301 controls the overall system 300. The bus master A 303 and the bus master B 304 may be, for example, peripheral devices of the CPU 301. The MEM 302 is a storage area that is accessible by the CPU 301. The MEM 302 is, for example, a ROM, a RAM, a magnetic disk, or an optical disc. The bus 305 is a path that is used to transmit data among the hardware elements (CPU 301, MEM 302, bus master A 303, and bus master B 304). The bus 305 is an arbitrating circuit that arbitrates transmission of data.

The system 300 may be modeled by coding with a description language for ESL design. An example of the description language for ESL design is SystemC. An ESL model is described on the basis of behaviors of the hardware elements. When the ESL model is given to an ESL simulator, a hardware environment described in the ESL model may be simulated. For example, the ESL simulation may be performed by causing the CPU 301 to execute firmware (hereinafter abbreviated as “FM”) 311.

FIG. 4 is a diagram illustrating an example of a delay (DLY) register, according to a first embodiment. A DLY register 400 stores a unit transmission time that is beforehand determined depending on source and destination hardware elements. For example, the DLY register 400 is configured to include fields of a source, a destination, a transmission overhead, and a unit transmission time. Records (for example, 401-1 and 401-2) are stored by setting information to the fields. The DLY register 400 may be implemented, for example, using the ROM 202, the RAM 203, the magnetic disk 205, or the optical disc 207, which is illustrated in FIG. 2.

In the field of a source, identification information identifying a source hardware element is set. In the field of a destination, identification information identifying a destination hardware element is set. In the field of a transmission overhead, a time for transmission overhead caused by the top of transmission is set. In the field of a unit transmission time, a transmission time per unit amount of data transmitted from the source hardware element to the destination hardware element is set.

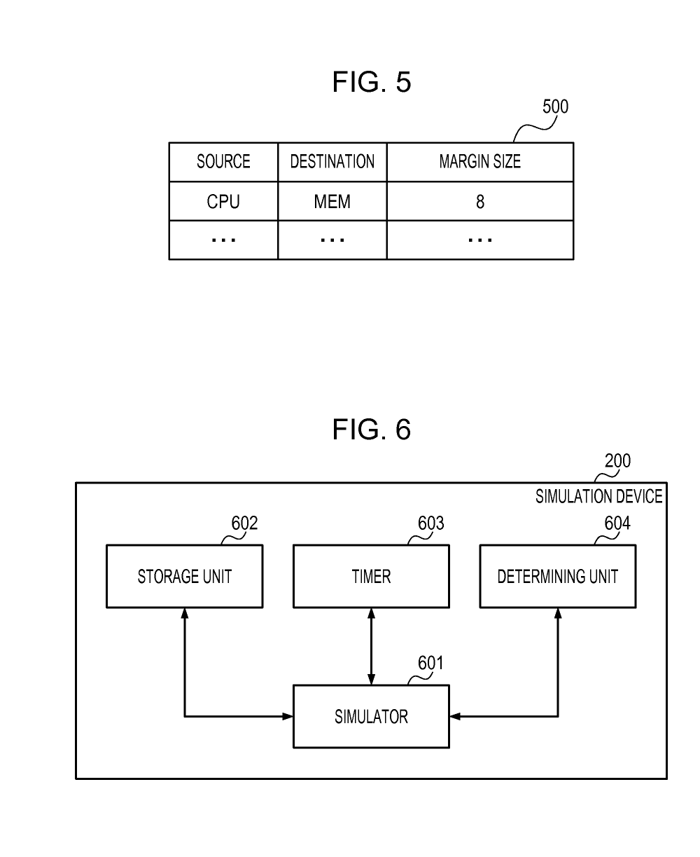

FIG. 5 is a diagram illustrating an example of a margin table, according to an embodiment. A margin table 500 has fields of a source, a destination, and a margin size. Records are stored in the margin table 500 by setting information in the fields. The margin table 500 is implemented, for example, by using the ROM 202, the RAM 203, the magnetic disk 205, or the optical disc 207.

In the field of the source, identification information identifying a source hardware element is set. In the field of the destination, identification information identifying a destination hardware element is set. In the field of the margin size, a margin data size relating to data transmission from the source hardware element to the destination hardware element is set. The margin data size is determined based on, for example, a type of the source hardware element, a type of the destination hardware element, a width of a bus, and a type of the bus. When a deviation in the operational timing occurs between the ESL simulation and the actual hardware, firmware, which has been executed on the ESL simulation without a problem, may not be executed on the hardware. To avoid this, a difference in operations between the ESL simulation and the hardware is set as a margin.

### Example of Functional Configuration of Simulation Device 200 According to First Embodiment

FIG. 6 is a diagram illustrating an example of a functional configuration of a simulation device, according to a first embodiment. The simulation device 200 may be configured to include a simulator 601, a storage unit 602, a timer 603, and a determining unit 604. A simulation program in which functions of the simulator 601 to the determining unit 604 are coded is stored in a storage device, such as the ROM 202, the magnetic disk 205, or the optical disc 207, as illustrated in FIG. 2. For example, the simulation program is information that represents the system 300. For example, the functions coded in the simulation program are implemented by causing the CPU 201 executing the ESL simulator to read the simulation program from the storage device and to provide the ESL simulator with the simulation program. For example, the CPU 201 provides the ESL simulator with both the simulation program and the FW 311.

The simulator 601 simulates a reception operation of the bus 305 receiving a request for permitting transmission of data from a source hardware element in a hardware group to a destination hardware element in the hardware group. The request includes identification information identifying the source hardware element, identification information identifying the destination hardware element, a start address of the transmission data within the source hardware element, the size of transmission data, and a priority of the transmission data. For example, the simulator 601 calculates, on the basis of the request, a time-period (hereinafter also referred to as “bus occupation time”) TBusNeed taken to transmit the transmission data from the source hardware element to the destination hardware element in the system 300. For example, the simulator 601 acquires a transmission overhead and a unit transmission time from the DLY register 400 on the basis of information on the source and destination hardware elements that are contained in the request. Then, the simulator 601 calculates the bus occupation time TBusNeed according to the following Equation (1).

The bus occupation time TBusNeed=(the transmission overhead)+(the unit transmission time)×(the size of transmission data) (1).

After the simulation of the reception operation of the bus 305, in accordance with the received request, the storage unit 602 saves, in a memory, as backup data, data that has been stored, by the simulation, in a storage area of the destination hardware element. Examples of the memory include the RAM 203, the magnetic disk 205, and the optical disc 207.

After the storage unit 602 has saved the data in the memory, the simulator 601 simulates, in accordance with the received request, an operation of storing the transmission data in the storage area of the destination hardware element.

The timer 603 measures, from a time-point at which the transmission data is stored in the storage area, a time-period taken to transmit the transmission data from the source hardware element to the destination hardware element in the system 300.

When first and second requests are received in this order, the determining unit 604 determines whether or not a priority of the second request, which has been received after the reception of the first request, is higher than a priority of the first request.

When the determining unit 604 determines that the second request has a higher priority than the first request, the simulator 601 performs, as the simulation, an operation of restoring a portion of a storage area of the destination hardware element for the first request to a state before the generation of the second request. For example, the simulator 601 performs, as the simulation, an operation of restoring a portion of the backup data saved in the memory for the first request, to the storage area of the destination hardware element for the first request. Here, the portion of the back data is determined based on an elapsed time-period that has elapsed from a time-point at which the first data has been stored in the storage area for the first request. For example, the simulator 601 specifies the size and start address of the portion of the backup data to be restored on the basis of the elapsed time-period that has elapsed from the time-point at which the first data was stored in the storage area for the first request, using the following equations (1) and (2).

The size of the data to be restored=(1−((the elapsed time-period)−(the transmission overhead))/((the bus occupation time TBusNeed)−(the transmission overhead)))×(the size of the data)+(a margin data size) (2)

The start address of the data to be restored=(the start address)+(((the elapsed time-period)−(the transmission overhead))/((the bus occupation time TBusNeed)−(the transmission overhead))×(the size of the data)−(the margin data size)) (3)

Further, as the simulation of the restoring operation, after the measurement for the second request is completed, the simulator 601 performs an operation of storing again the first data for the first request in the storage area of the destination hardware element for the first request. “After the measurement for the second request is completed” means “after a time-period taken to transmit second data for the second request has been measured from a time-point at which the second data is stored in the storage area for the second request”.

Further, when the determining unit 604 determines that the second request has a higher priority than the first request, the timer 603 adds a time-period measured for the second request to a time-period measured for the first request. The timer 603 calculates the sum of first and second time-periods to obtain a third time period where the first time-period is obtained by subtracting an elapsed time for the first request from a time-period taken to transmit first data for the first request and the second time-period is a time-period taken to transmit second data for the second request. The timer 603 measures the third time-period from a time-point up to which the elapsed time for the first request has elapsed from a time-point of storing the first data for the first request. More specifically, when the determining unit 604 determines that the second request has a higher priority than the first request, the timer 603 suspends the measurement of a time-period from a time-point at which the first data was stored in the storage area for the first request. Then, after the restoring operation mentioned above is performed, the timer 603 restarts the suspended measurement for the first request so that a time-period for the second request is measured from a time-point at which the second data is stored in a storage area for the second request.

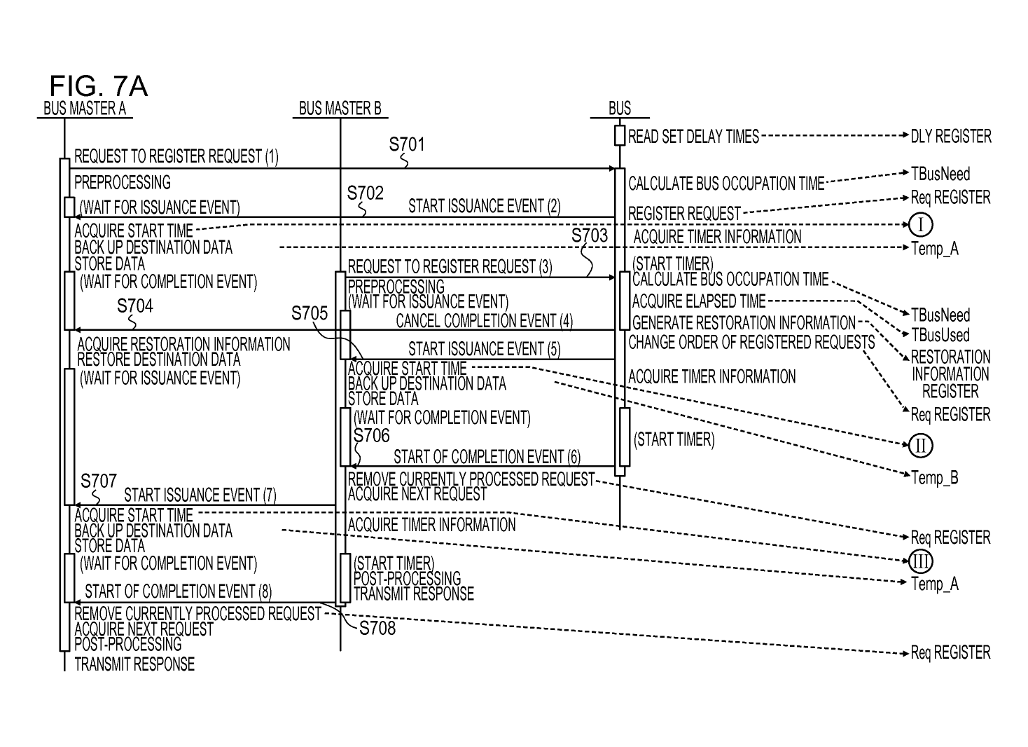

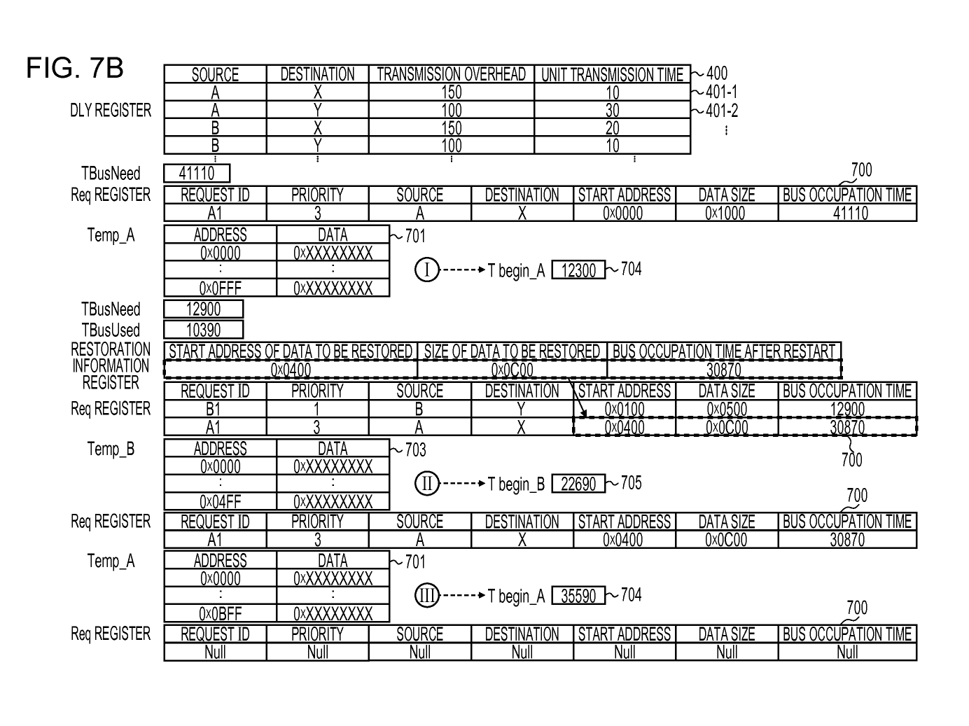

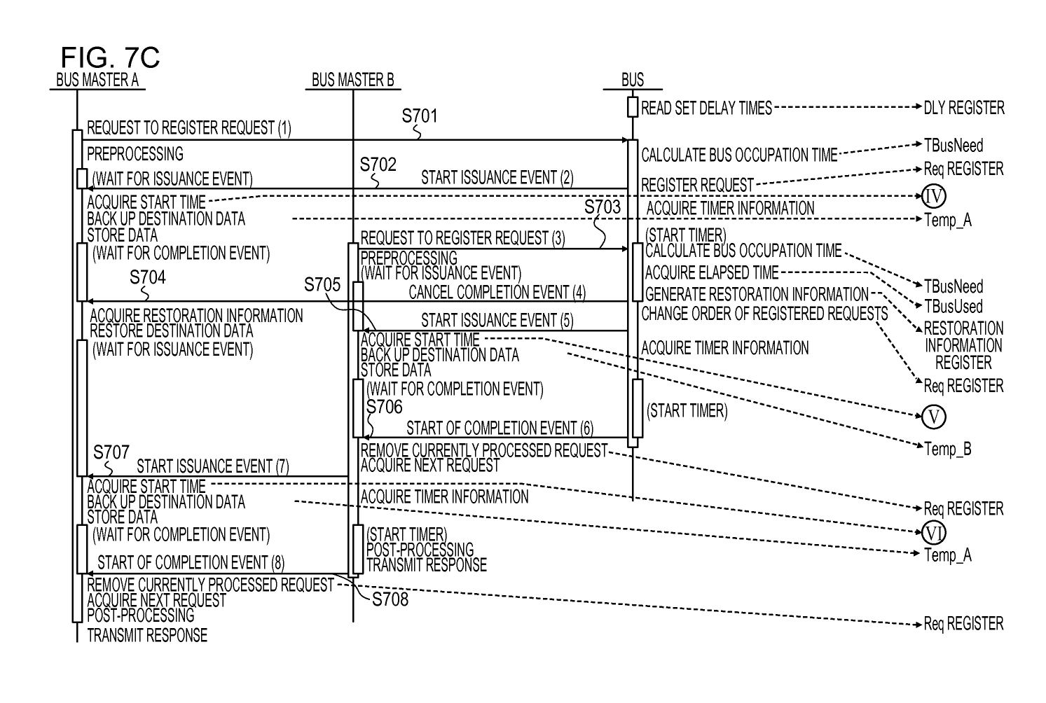

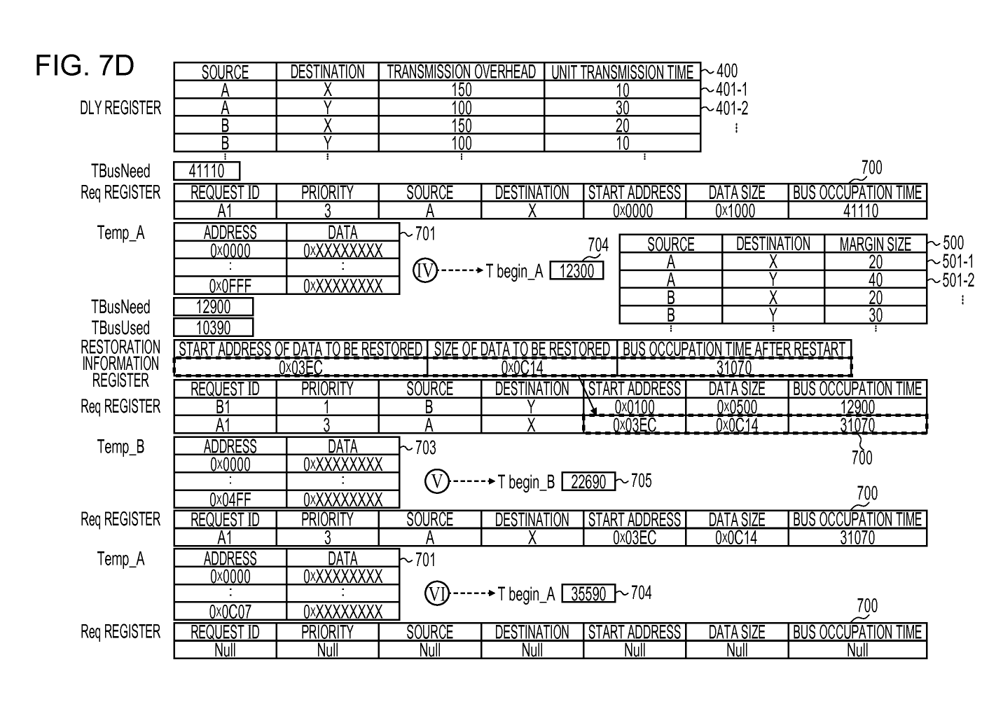

When the determining unit 604 determines that a priority of the first request is not lower than that of the second request, after the measurement for the first request is completed, the simulator 601 simulates an operation of data transmission for the second request. “After the measurement for the first request is completed” means “after a time-period taken to transmit the first data for the first request has been measured from a time-point at which the first data for the first request is stored in the storage area”. For example, in accordance with the second request, the simulator 601 saves, in the memory, as backup data, data that has been stored, by the simulation, in the storage area of the destination hardware element for the second request. Examples of details of the simulation are described with reference to sequence diagrams of FIGS. 7A to 7C.

Sequence Diagrams

FIGS. 7A to 7D are diagrams illustrating examples of an operational sequence for event control, according to a first embodiment. FIGS. 7A to 7D illustrate simulation processes that are performed by the bus 305, the bus master A 303, and the bus master B 304. In FIGS. 7A and 7C, for ease of explanation, the simulation processes thereof are simply expressed as the bus 305, the bus master A 303, and the bus master B, respectively. FIGS. 7A and 7B illustrate an example of an operational sequence for which the margin data size used in Equations 2 and 3 is not considered, while FIGS. 7C and 7D illustrate an example of an operational sequence for which the margin data size is considered. FIGS. 7A and 7B are described below before a description of FIGS. 7C and 7D.

In the sequence of FIG. 7A, the bus 305 reads the DLY register 400 as preprocessing. The bus master A 303 notifies the bus 305 of a request to register a first request (1) (in step S701). The request to register the first request includes identification information identifying a source hardware element, identification information identifying a destination hardware element, a start address, a data size, and a priority.

Upon receiving the request to register the first request A1 from the bus master A 303, the bus 305 calculates a bus occupation time TBusNeed. For example, the bus 305 acquires a transmission overhead and a unit transmission time from the DLY register 400, based on information on the source and destination hardware elements. The bus 305 calculates the bus occupation time TBusNeed according to Equation (1).

In the example of FIGS. 7A and 7B, the bus occupation time TBusNeed is “41110”. The bus 305 registers the first request A1 in a Req register 700 by associating the request to register the first request A1, with the calculated bus occupation time TBusNeed. The Req register 700 has a queue structure, and the requests are processed in order in which the requests are input to the Req register 700. In this example, since another request is not registered in the Req register 700, the first request A1 provided by the bus master A 303 is registered at the head of the Req register 700. For example, information items of a request ID, a priority, a source, a destination, a start address, a data size, and a bus occupation time are registered as a first record in the Req register 700.

The bus 305 notifies the bus master A 303 of the start of an issuance event (2) (in step S702). When receiving the notification indicating the start of the issuance event from the bus 305, the bus master A 303 acquires the current time as a start time and stores the acquired time as saved data TBegin_A704. The bus master A 303 replicates data (referred to as “destination data” in FIG. 7A) that has been stored, by the simulation, in the storage area of the destination hardware elements so as to back up the data. The replicated data is saved as backup data Temp_A701, for example. The bus master A 303 performs a simulation of transmitting first data to the destination hardware element by storing the first data in the storage area of the destination hardware element. Then, the bus master A 303 waits for a completion event from the bus 305. The bus 305 starts a timer in accordance with the first request A1.

The bus master B 304 notifies the bus 305 of a request to register a second request B1 (3) (in step S703). The bus 305 calculates a bus occupation time TBusNeed. Since the first request A1 is already registered in the Req register 700, the bus 305 compares a priority of the first request A1 registered in the Req register 700, with a priority of the newly received second request B1. In this example, a priority of the newly received second request B1 is higher than a priority of the first request A1 registered in the Req register 700. Thus, the order in which the requests are to be processed is changed.

The bus 305 acquires the current time and the saved data TBegin_A704 that includes the start time for the first request issued from the source hardware element registered in the Req register 700. The bus 305 obtains the difference between the current time and the acquired start time 704 as an elapsed time-period TBusUsed for the first request A1. The bus 305 acquires a margin data size from a margin table 500, based on information on the source and destination hardware elements. The bus 305 generates restoration information on the basis of the elapsed time TBusUsed and the margin data size. The restoration information includes the size of data to be restored and a start address of the data to be restored. The bus 305 generates the size of the data to be restored according to the aforementioned Equation (2) and generates the start address of the data to be restored according to the aforementioned Equation (3). The bus 305 generates a bus occupation time TBusNeed after the restart, according to the following Equation (4). The bus 305 stores the generated restoration information in a restoration information register.

The bus occupation time TBusNeed after the restart=(the transmission overhead)+(the unit transmission time)×(the size of the data to be restored) (4)

Next, the bus 305 notifies the bus master A 303 of cancellation of the completion event (4) (in step S704), where the bus master A 303 is the source hardware element for the first request registered in the Req register 700. The notification that indicates the cancellation of the completion event includes the restoration information.

When receiving the notification indicating the cancellation of the completion event, the bus master A 303 restores a portion of the backup data Temp_A701 to the storage area of the destination hardware element on the basis of the start address of the data to be restored and the size of the data to be restored. Then, the bus master A 303 waits for an issuance event.

The bus 305 changes the order of the requests registered in the Req register 700 to arrange the requests in the order of ascending priorities of requests. In the first embodiment, priorities are indicated by positive integers that are 1, 2, 3 and the like, where the smaller the positive integer, the higher the priority. The priorities are not limited to the positive integers and may be changed.

The bus 305 notifies the bus master B 304 of the start of an issuance event (5) (in step S705), where the bus master B 304 is the source hardware element for the second request B1 registered at the head of the Req register 700.

Upon receiving the notification indicating the start of the issuance event, the bus master B 304 acquires the current time as a start time for the second request B1 and stores the acquired time as saved data TBegin_B705. The bus master B 304 replicates data that has been stored, by the simulation, in the storage area of the destination hardware element so as to back up the data. The replicated data is saved as backup data Temp_B703, for example. Then, the bus master B 304 simulates an operation of transmitting second data for the second request B1 by storing the second data in the storage area of the destination hardware element. The bus master B 304 waits for a completion event. The bus 305 starts a timer for the request B1.

When the timer expires for the second request B1, the bus 305 notifies the bus master B 304 of the start of the completion event (6) (in step S706). Upon receiving the notification indicating the start of the completion event, the bus master B 304 determines that the processing on the second request B1 has completed and removes the second request B1 from the Req register 700.

Then, the bus master B 304 acquires the first request A1 from the Req register 700. The bus master B 304 notifies the bus master A 303 of the start of an issuance event (7) (in step S707), where the bus master A 303 is the source hardware element that has transmitted the first request A1. Upon receiving the notification indicating the start of the issuance event, the bus master A 303 acquires the current time as a start time and stores the acquired time as the saved data TBegin_A704. The bus master A 303 replicates data that has been stored, by the simulation, in the storage area of the destination hardware element so as to back up the data. The replicated data is saved as backup data Temp_A701, for example. Then, the bus master A 303 restarts the simulation of an operation of transmitting the first data for the first request A1 by storing the first data in the storage area of the destination hardware element. The bus master A 303 waits for a completion event. The bus master B 304 restarts a timer for the first request A1.

After starting the timer for the request A1, the bus master B 304 executes post-processing and transmits a response. When the timer expires for the first request A1, the bus master B 304 notifies the bus master A 303 that has issued the first request A1, of the start of a completion event (8) (in step S708). Upon receiving the notification indicating the start of the completion event, the bus master A 303 removes the first request A1 from the Req register 700. Although the bus master A 303 tries to acquire the next request from the Req register 700, the Req register 700 is empty. Thus, the bus master A 303 executes post-processing, transmits a response, and terminates the event control.

Next, FIGS. 7C and 7D are described. As described above, FIGS. 7C and 7D illustrate an operational sequence for which the margin data size is considered. The difference between a process described with reference to FIGS. 7A and 7B and a process described with reference to FIGS. 7C and 7D is whether or not the margin data size is provided for generation of restoration information. The generation of the restoration information is described in detail below, and differences between setting values illustrated in FIGS. 7B and 7D are described below.

The bus 305 generates the restoration information on the basis of the elapsed time TBusUsed and the margin data size. The restoration information includes a start address of data to be restored and the size of the data to be restored. The bus 305 generates the size of the data to be restored according to the aforementioned Equation (2) and generates the start address of the data to be restored according to the aforementioned Equation (3). In the case, the start address of the data to be restored is as follows.

The start address of the data to be restored=0x000+((10390−150)/(41110−150))*0x1000−20=0x03EC

The start address of the data to be restored is 0x0400 in FIG. 7B, while the start address of the data to be restored is 0x03EC in FIG. 7D. The size of the data to be restored is as follows.

The size of the data to be restored=(1−(10390−150))/(41110−150)*0x1000+20=0x0C14

The size of the data to be restored is “0x0C00” in FIG. 7B, while the size of the data to be restored is “0x0C14” in FIG. 7D. The bus 305 generates the bus occupation time TBusNeed after the restart, according to the aforementioned Equation (4). In this case, the bus occupation time TBusNeed after the restart is as follows.

The bus occupation time TBusNeed after the restart=150+0x0C00*10=31070

The bus occupation time TBusNeed after the restart is “30870” in FIG. 7B, while the bus occupation time TBusNeed is “31070” in FIG. 7D. The bus 305 stores the generated restoration information in the restoration information register.

The processes (4) to (7) executed in the sequence of FIG. 7A are the same as the processes (4) to (7) executed in the sequence of FIG. 7C. Although the bus master A303 backs up the data stored in the destination hardware element after the process (7), the data backed up in the sequence of FIG. 7A is different from the data backed up in the sequence of FIG. 7C. Data to be registered as the backup data Temp_A701 (depicted after the sequence (7) in the figures) are up to 0x0BFF in the sequence of FIG. 7A and are up to 0x0C07 in the sequence of FIG. 7C.

Process Procedure to be Executed by Source Hardware Element

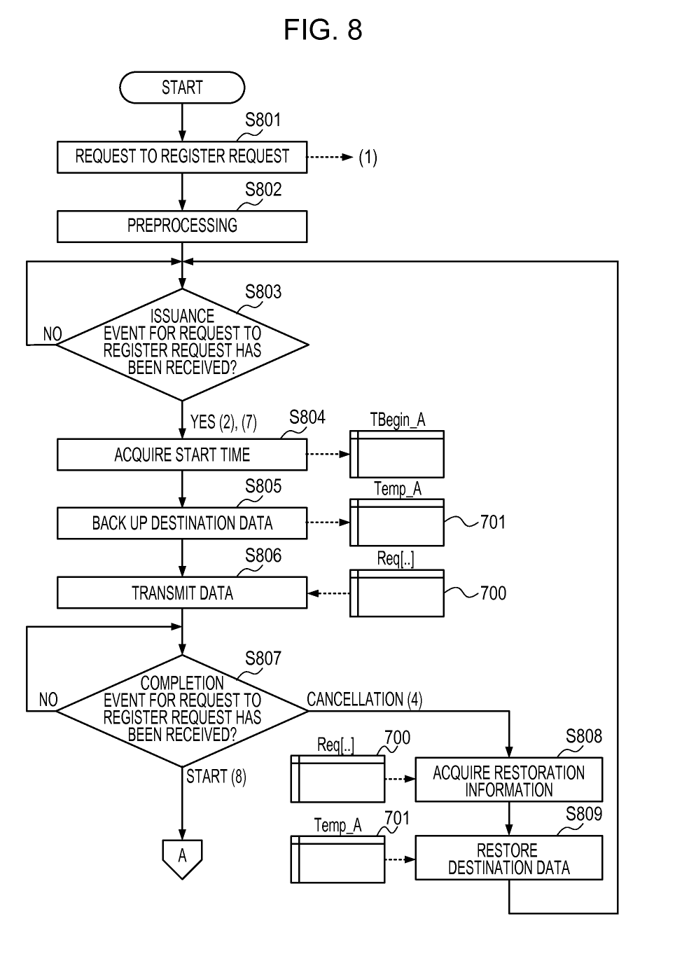

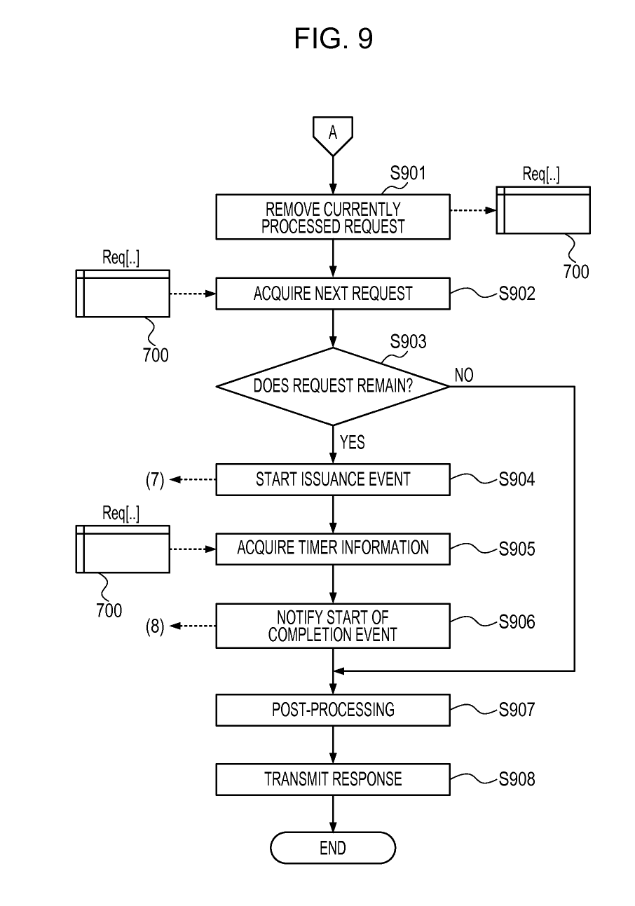

FIGS. 8 and 9 are diagrams illustrating an example of an operational flowchart performed by a source hardware element, according to a first embodiment. The operational flowchart performed by a source hardware element means an operational flowchart that is performed, as the simulation, by the source hardware element and does not mean an operational flowchart to be actually performed by the source hardware element. Numbers in parentheses in FIGS. 8 and 9 correspond to the numbers in parentheses in FIG. 7A.

The source hardware element notifies the bus 305 of a request to register a request (in step S801) and executes preprocessing (in step S802). The source hardware element determines whether or not the source hardware element has received an issuance event for the request to register the request (in step S803).

When the source hardware element has not received the issuance event for the request to register the request (No in step S803), the process procedure returns to step S803 so that the source hardware element waits for the issuance event for the request to register the request (wait (ev_A1)).

When the source hardware element has received the issuance event for the request to register the request (No in step S803), the source hardware element acquires the current time as a start time TBegin_A704 (in step S804). The source hardware element backs up data (destination data) stored in a storage area of destination hardware element by saving the data (the destination data) as backup data Temp_A701 (in step S805). The source hardware element transmits data (in step S806). In data transmission of the event-driven ESL simulation, the transmission data is directly written in the storage area of the destination hardware element by the simulation.

The source hardware element determines whether or not the source hardware element has received a completion event for the request to register the request (in step S807). When the source hardware element has not received the completion event for the request to register the request (No in step S807), the process procedure returns to step S807. Thus, the source hardware element waits for the completion event for the request to register the request (wait (ev_A2)).

When the source hardware element has received cancellation of the completion event (cancellation in step S807), the source hardware element acquires the restoration information (in step S808) and restores the destination data stored in the destination hardware element (in step S809). Then, the process procedure returns to step S803.

When the source hardware element has received the completion event (start in step S807), the source hardware element removes a currently processed request (in step S901) and acquires a next request from the Req register 700 (in step S902). The source hardware element determines whether or not another request remains in the Req register 700 (in step S903). When another request does not remain in the Req register 700 (No in step S903), the process procedure proceeds to step S907.

When another request remains in the Req register 700 (Yes in step S903), the source hardware element notifies a source hardware element that has issued the request registered at the head of the Req register 700, of the start of an issuance event (in step S904). The source hardware element acquires timer information of the request for which the start of the issuance event has been notified (in step S905). The source hardware element notifies the source hardware element that has issued the request, of the start of a completion event (in step S906). The source hardware element executes post-processing (in step S907), transmits a response (in step S908), and terminates the process procedure. In the case, although the start of the completion event is notified before steps S907 and S908, the completion event is started after a bus occupation time TBusNeed has elapsed from a time-point at which the issuance event was started. Therefore, the completion event is started after steps S907 and S908. In this case, the source hardware element notifies a source hardware element that has issued the remaining request, of the start of the issuance event and the start of the completion event for the remaining request. In this way, instead of the bus 305 on which a large load caused by executing a process on events of a plurality of hardware elements is imposed, other hardware elements may execute the process. Thus, the load of the bus caused by the simulation may be reduced, thereby shortening a time-period required for the simulation.

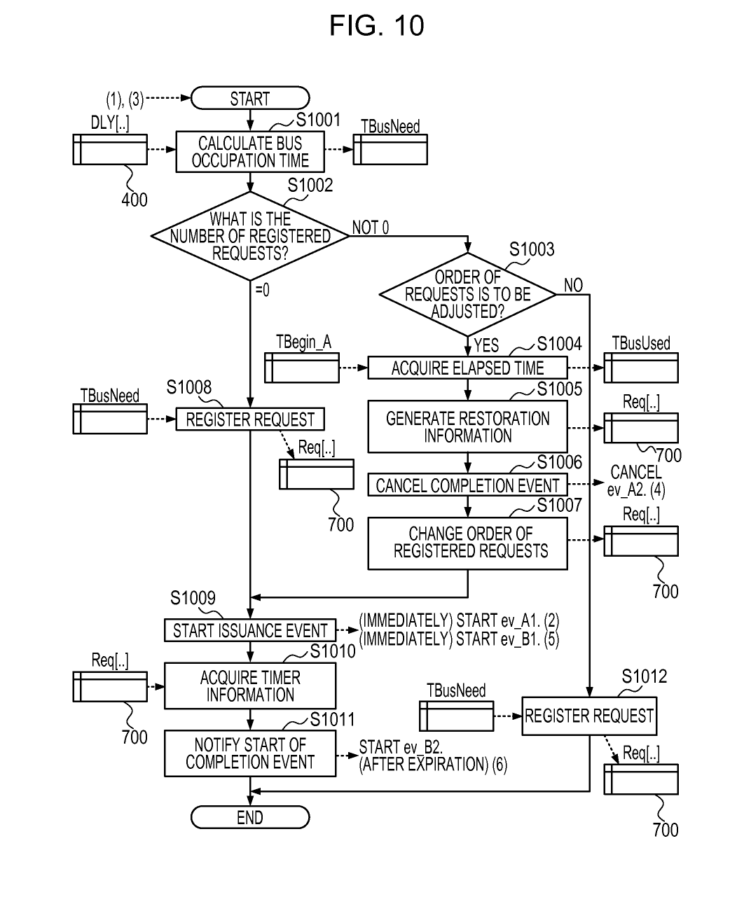

FIG. 10 is a diagram illustrating an example of an operational flowchart performed by a bus, according to a first embodiment. In this case, the operational flowchart performed by the bus 305 means an operational flowchart performed, as the simulation, by the bus 305 and does not mean an operational flowchart actually executed by the bus 305. Numbers in parentheses in FIG. 10 correspond to the numbers in the parentheses in FIGS. 7A and 7C.

Upon receiving a request to register a request, the bus 305 calculates a bus occupation time TBusNeed by acquiring a unit transmission time from the DLY register 400 on the basis of information on source and destination hardware elements (in step S1001). The bus 305 determines the number of requests registered in the Req register 700 (in step S1002). The bus occupation time TBusNeed is calculated using the aforementioned Equation (1).

When the number of registered requests is not 0 (Not 0 in step S1002), the bus 305 compares priorities of the requests registered in the Req register 700 with the priority of the received request and thereby determines whether to adjust the order of the requests in order of the priorities of the requests (in step S1003). When the order is to be adjusted (Yes in step S1003), the bus 305 acquires an elapsed time TBusUsed that is the difference between the current time and a start time for the request (in step S1004). The bus 305 generates restoration information (in step S1005) and notifies source hardware element that has issued the currently processed request, of cancellation of the completion event (in step S1006). Here, the restoration information is generated using the aforementioned Equations (2) to (4). The bus 305 places the received request at the head of the Req register 700 and changes the order of the registered requests (in step S1007).

When the number of registered requests is 0 in step S1002 (=0 in step S1002), the bus 305 registers the received request at the head of the Req register 700 (in step S1008). After step S1007 or S1008, the bus 305 notifies a source hardware element that has issued the request registered at the head of the Req register 700, of the start of an issuance event (in step S1009).

Then, the bus 305 acquires timer information (in step S1010), notifies the source hardware element that has issued the request, of the start of a completion event (in step S1011) and terminates the process procedure. Although a process of notifying the source hardware element of the start of the completion event is invoked in step S1011, in actuality, the bus 305 notifies the source hardware element that has issued the request, of the start of the completion event, when the bus occupation time TBusNeed has elapsed from a time-point at which the bus 305 notified the source hardware element that has issued the request, of the start of the issuance event.

When the order is not adjusted (No in step S1003), the bus 305 registers the received request in the Req registers 700 in accordance with the priorities of the requests (in step S1012) and terminates the process procedure.

As described above, in the simulation 100 according to the first embodiment, when, after generation of a first request, a second request having a higher priority than the first request is generated, a portion of a storage area of the destination hardware element for the first request is restored, by the simulation, to a state before the generation of the first request. Thus, suspension of the data transmission for the first request, which is caused by the second request, may be properly simulated. In the simulation according to the first embodiment, after the second request is completely processed, the remaining transmission data for the first request is restored in the storage area of the destination hardware element for the first request. Thus, the restart of the data transmission for the first request after the processing on the second request is completed may be properly simulated. Thus, a result of the event-driven ESL simulation may be close to a result of an actual hardware operation.

In the simulation 100 according to the first embodiment, the measurement of a first time-period for data transmission of the first request is extended by a second time-period measured for the second request. Thus, the delay in completion of the data transmission for the first request, which is caused by the second request, may be properly simulated. Thus, a result of the event-driven ESL simulation may be close to a result of an actual hardware operation.

In the simulation 100 according to the first embodiment, when a priority of the first request is not lower than a priority of the second request, transmission of data for the second request is simulated after the measurement for the first request is completed, thereby allowing the arbitration function of the bus to be simulated. Thus, a result of the event-driven ESL simulation may be close to a result of an actual hardware operation.

In the simulation 100 according to the first embodiment, a portion of the backup data for the first request is determined based on a ratio of a time-period that has elapsed from a time-point at which the transmission data was stored for the first request, to a time-period estimated to be taken to transmit the transmission data for the first request, and the determined portion is restored to the storage area of the destination hardware element for the first request. Thus, the amount of data transmitted during the suspension of the data transmission for the first request, which is caused by the second request, may be more accurately simulated. Thus, a result of the event-driven ESL simulation may be close to a result of an actual hardware operation. In the simulation 100 according to the first embodiment, the above mentioned ratio may be corrected using a margin data size that is determined based on, for example, the type of source hardware element, the type of destination hardware element, the width of the bus, and the type of the bus.

### Second Embodiment

In the second embodiment, event-driven simulation is performed on an operation of a memory. Traditionally, in an operation of the actual hardware, when a process of reading data is invoked during a process of writing data responsive to a request for writing the data, mixed data of the rewritten data and the data before being rewritten may be read out. This is due to the fact that the reading process is executed in parallel with the writing process. In the event-driven ESL simulation, since data changes only upon the occurrence of an event, a time-point at which the data is written in the memory is different from that of the actual hardware. Thus, when a read request is detected during a time-period for writing data, data different from that of the actual hardware may be read out.

In simulation of a first operation according to a second embodiment, when a request to write second data is detected in a state of first data being stored in a first storage area, the first data is stored in a second storage area and the second data is stored in the first storage area. In the simulation of the first operation, when a read request is detected within a predetermined time-period after the write request is detected, collection data including the first and second data complying with a time-point at which the read request is detected, and result data determined based on the collection data is stored in a third storage area so that the result data is read out from the third data. Thus, even when the read request is detected during a time-period for a writing process, data that is the same as that of the actual hardware may be read out.

The simulation of the first operation may provide an event-driven simulation result that is close to a result of an operation of the memory of the actual hardware. A request to write data in a memory is generated by hardware accessible to the memory, and the request to read data from the memory is generated by hardware or software that is accessible to the memory. Since the types of hardware and the software are not limited here, a detailed example of a system that includes the memory is omitted.

Before the second embodiment is described in detail, an actual hardware operation is described in order to facilitate understanding.

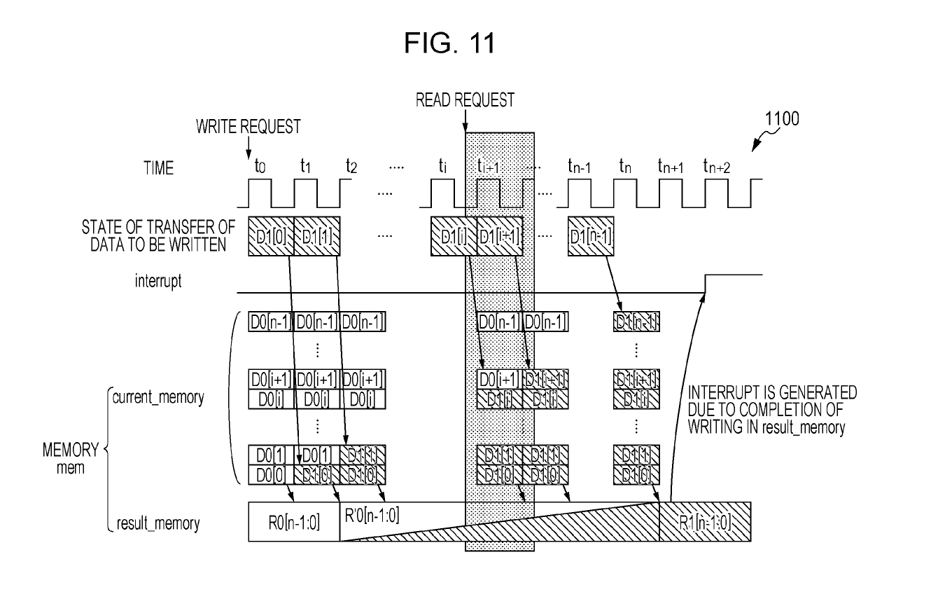

FIG. 11 is a diagram illustrating an example of a hardware operation. A timing chart 1100 indicates a state in which a request to write data in a memory “mem” that is actual hardware is generated and a state in which a read request is generated during a writing process.

The memory mem has a buffer “current_memory” and a storage area “result_memory”. The buffer current_memory is a first-in-first-out (FIFO) buffer. Data that is received by the memory mem and to be written is sequentially stored in the buffer current_memory. The storage area result_memory is a storage area formed by a plurality of actual memory elements. From first data stored in the buffer current_memory, second data is determined and stored in the storage area result_memory. The second data determined from the first data stored in the buffer current_memory may be the first data or may be data obtained by coding or encrypting the first data.

For example, at a time t₀, first data D0 [n−1:0] is stored in the buffer current_memory, and R0 [n−1:0] that is second data determined from the first data is stored in the storage area result_memory. The symbol n is an integer of 1 or more. When first data to be written in the hardware starts to be transferred at the time-point t₀, the first data is sequentially stored in the buffer current_memory. Hereinafter, second data that is determined from first data stored in the buffer current_memory and stored in the storage area result_memory will be also referred to as “result data”.

At a time-point t₁, data D0 [n−1:1] and D1 [0] is stored in the buffer current_memory. At the time-point t₁, result data determined from the data stored in the buffer current_memory at the time-point t₀ is stored in the storage area result_memory.

For example, when a read request is detected at a time-point tᵢ₊₁, the memory mem reads result data R′0 [n−1:0] from the storage area result_memory and returns data determined based on the result data R′0 [n−1:0] to a source of the read request.

Then, data R1 [n−1:0] that is result data determined from data D1 [n−1:0] stored in the buffer current_memory is stored in the storage area result_memory. The memory mem determines that the writing process executed in accordance with the write request has been completed. Then, the memory mem generates an interrupt signal. For example, the memory mem changes a value of the interrupt signal from 0 to 1 so as to indicate that the memory mem is in a state able to receive the next write request and the next read request.

Next, a simulation device 1200 according to a second embodiment is described in detail. A hardware configuration according to the second embodiment may be the same as the hardware configuration described in the first embodiment, and a description thereof is omitted here.

### Example of Functional Configuration of Simulation Device According to Second Embodiment

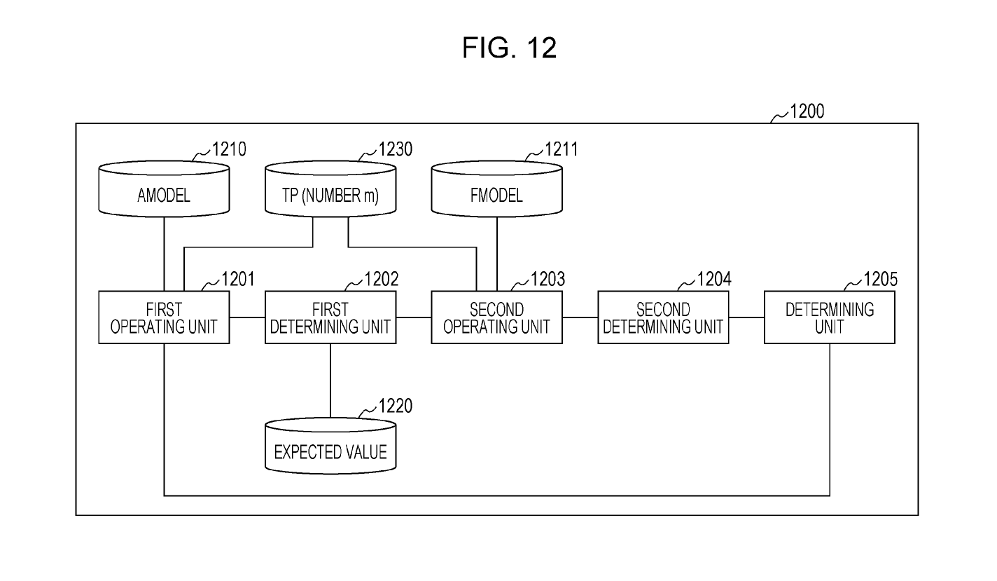

FIG. 12 is a diagram illustrating an example of a functional configuration of a simulation device, according to a second embodiment. The simulation device 1200 includes a first operating unit 1201, a first determining unit 1202, a second operating unit 1203, a second determining unit 1204, and a determining unit 1205. For example, a simulation program including coded functions of the units 1201 to 1205 is stored in a storage device, such as the ROM 202, the magnetic disk 205, or the optical disc 207, which is illustrated in FIG. 2. The CPU 201, which is configured to execute the ESL simulator, reads the simulation program from the storage device and executes a process coded in the simulation program, thereby performing processes of the units 1201 to 1205. In addition, results of the processes of the units 1201 to 1205 are stored in a storage device, such as the RAM 203, the magnetic disk 205, or the optical disc 207.

A memory model represents the memory mem including a first storage area, a second storage area, and a third storage area. A hardware model represents other hardware or a CPU able to execute software and FW. A model 1210 representing a system including the memory model and the hardware model is stored in a storage device, such as the ROM 202, the magnetic disk 205, or the optical disc 207. The first storage area is a buffer current_memory, the second storage area is a storage area previous_memory, and the third storage area is a storage area result_memory. A method for describing the memory model representing the memory mem including the first storage area, the second storage area, and the third storage area is referred to as AMODEL. The first operating unit 1201 performs the event-driven ESL simulation on a first operation of the memory mem using the model 1210 and any one of the number m (m is an integer of 1 or more) of test patterns (TPs) 1230. The TPs 1230 are data that is input to the first and second operating units 1201 and 1203 so as to verify that hardware operates in accordance with requested specifications and software is executed in accordance with requested specifications, and the obtained outputs are observed. An appropriate TP 1230 is determined based on the operational specifications of hardware to be verified. In order to verify the hardware in accordance with different types of specifications, a plurality of TPs 1230 that are appropriate for the specifications are prepared. In this example, the number m of the TPs 1230 are prepared. The TPs 1230 may be beforehand stored in a storage device, such as the ROM 202, the magnetic disk 205, or the optical disc 207.

In addition, a model 1211 representing a system including a memory model and a hardware model may be stored in a storage device, such as the ROM 202, the magnetic disk 205, or the optical disc 207, where the memory model represents a memory mem that has a first storage area and a third storage area, and the hardware model represents other hardware or a CPU configured to execute software and FW. The first storage area is the buffer current_memory, and the third storage area is the storage area result_memory. A method for describing the memory model that represents the memory mem including the first and third storage areas is referred to as FMODEL. The second operating unit 1203 performs the event-driven ESL simulation on a second operation of the memory mem using the model 1211 and any one of the number m of the TPs 1230.

The models 1210 and 1211 are obtained by coding the systems using a description language for ESL design. As described above, the ESL models are described on the basis of behaviors of the hardware elements. Hardware environments that are described in the ESL models may be simulated by providing the ESL simulator with the ESL models. For example, when a CPU is included in a system to be subjected to the ESL simulation, the CPU executes software or FW to perform the ESL simulation. Next, details of the units are described.

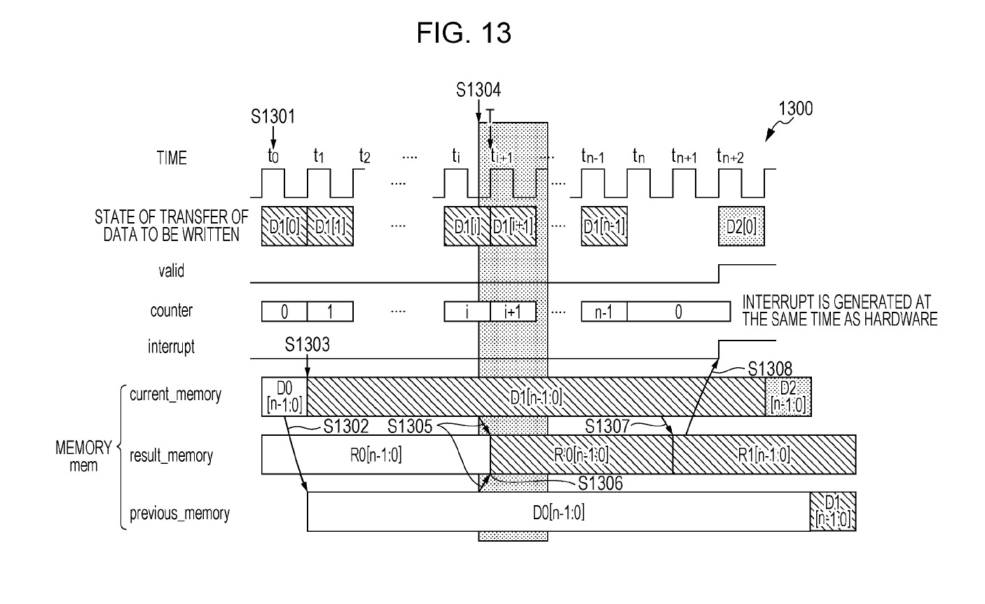

FIG. 13 is a diagram illustrating an example of a first operation, according to a second embodiment. A timing chart 1300 indicates a state in which a request to write data in the memory mem that is the actual hardware is generated in the event-driven simulation of the first operation of the memory mem and a state in which a request to read data from the memory mem is generated during a writing process in the event-driven simulation of the first operation of the memory mem.

As illustrated in FIG. 13, instead of the clock signal, a valid signal and a counter are provided where the valid signal indicates that data to be processed by a writing process is being received and the counter counts a predetermined time-period during which the data is to be received. In the example illustrated in FIG. 13, the counter counts numbers from 0 to n−1 (n is an integer of 1 or more). The valid signal and the counter may not be used when the data is not read out within the predetermined time-period. For example, when software and FW are normally executed, a read request is not generated during a time-period in which writing processing is being performed on the memory mem since the read request is generated only in response to an interrupt signal. On the other hand, when the execution of the software or the FW fails, a read request may be generated from the software or the FW even during a time-period in which writing processing is being performed on the memory mem. In addition, when other hardware fails, read requests may be generated at inappropriate times from the other hardware.

At the time-point t₀, the first data D0 [n−1:0] is stored in the buffer current_memory. In this state, the first operating unit 1201 simulates an operation of the memory mem detecting a request to write the second data D1 [n−1:0] in the memory mem (in step S1301). Then, the first operating unit 1201 simulates an operation of the memory mem storing, in the storage area previous_memory, the first data D0 [n−1:0] stored in the buffer current_memory at the time-point t₁ in response to the detection of the write request (in step S1302). Thus, the first data D0 [n−1:0] is stored in the storage area previous_memory at the time-point t₁.

Next, the first operating unit 1201 simulates an operation of the memory mem storing the second data D1 [n−1:0] in the buffer current_memory (in step S1303). Thus, the second data D1 [n−1:0] is stored in the buffer current_memory at the time-point t₁.

Then, the first operating unit 1201 simulates an operation of the memory mem detecting a request to read data from the memory mem within a predetermined time-period after the detection of the write request (in step S1304). The first operating unit 1201 simulates an operation of the memory mem storing, in the storage area result_memory, in response to the detection of the read request, result data that is determined from data complying with a time-point at which the read request is detected (in step S1305). The data complying with a time-point at which the read request is detected is referred to as “collection data”. The collection data is data that is included in both the second data D1 [n−1:0] stored in the buffer current_memory and the first data D0 [n−1:0] stored in the storage area previous_memory.

For example, when the value of the counter is i+1, the collection data includes data D1 [i:0] contained in the second data D1 [n−1:0] stored in the buffer current_memory and data D1 [n−1:i+1] contained in the first data D0 [n−1:0] stored in the storage area previous_memory. The result data determined from the collection data may be the collection data itself or data obtained by performing calculation, such coding or encrypting, on the collection data.

The first operating unit 1201 simulates an operation of reading data from the storage area result_memory in accordance with a read request (in step S1306). For example, in the reading operation, the result data that is stored in the storage area result_memory may be read out and transmitted to a source of the read request without a change. In the case where the result data has been coded or encrypted, the result data may be transmitted after being decoded or decrypted.

Next, the first operating unit 1201 simulates an operation of the memory mem storing, in the storage area result_memory, result data determined from the data stored in the buffer current_memory when a predetermined time has elapsed after the detection of the write request (in step S1307). The data stored in the buffer current_memory is the second data D1 [n−1:0], while the result data determined from the second data D1 [n−1:0] is the data R1 [n−1:0].

Then, the first operating unit 1201 simulates an operation of outputting information indicating completion of the write request (in step S1308). For example, the first operating unit 1201 simulates an operation of the memory mem outputting an interrupt signal in the same manner as the operation of the actual hardware. For example, the first operating unit 1201 simulates an operation of the memory mem changing the value of the interrupt signal from 0 to 1.

Thus, an event-driven simulation result that is close to a result of the operation of the actual memory mem may be obtained.

The timing of changing an operation of the actual hardware in accordance with the clock signal may not match the timing of changing an operation in accordance with a value counted by the counter in the ESL simulation. In the case, the result data determined from the collection data complying with the timing illustrated in FIG. 13 may be different from data stored in the actual hardware due to the difference between the timings.

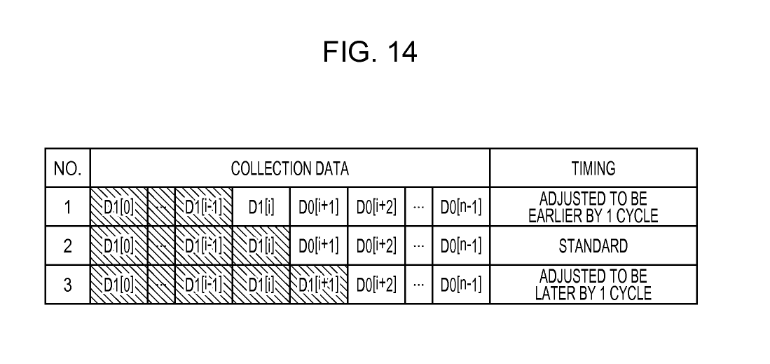

To deal with the problem, for example, the first operating unit 1201 first simulates the operations of steps S1301 to S1304 in the same manner as described above. Next, the first operating unit 1201 simulates an operation of storing, in the third storage area, result data that is determined from the collection data complying with a different time-point that is deviated by a predetermined time from a time-point at which the read request is detected. The collection data is data that is included in the data D1 [n−1:0] stored in the buffer current_memory of the memory mem and the data D0 [n−1:0] stored in the storage area result_memory of the memory mem. The predetermined time may be one cycle as illustrated in FIG. 13 or may be two or more cycles. The predetermined time is stored in a storage device, such as the ROM 202, the magnetic disk 205, or the optical disc 207. Collection data that is used for generation of result data to be stored in the storage area result_memory at the time-point tᵢ₊₁ may be configured as data illustrated in FIG. 14.

FIG. 14 is a diagram illustrating an example of collection data, according to a second embodiment. Collection data indicated by No. 2 is the aforementioned data D1 [i:0] and the data D0 [n−1:i+1]. Collection data indicated by No. 1 is data that is expected to be collected at a time-point that is earlier by one cycle or approximately one cycle than a time-point T at which the data indicated by No. 2 is collected. The collection data indicated by No. 1 is data D1 [i−1:0] and data [n−1:i]. Collection data indicated by No. 3 is data that is expected to be collected at a time-point that is later by one cycle or approximately one cycle than the time-point T at which the data indicated by No. 2 is collected. The collection data indicated by No. 3 is data D1 [i+1:0] and data D0 [n−1:i+2].

The simulation of operations of generating the collection data on the basis of the differences between the timings is effective to verify a failure of the actual hardware, but the effectiveness thereof is not limited to this.

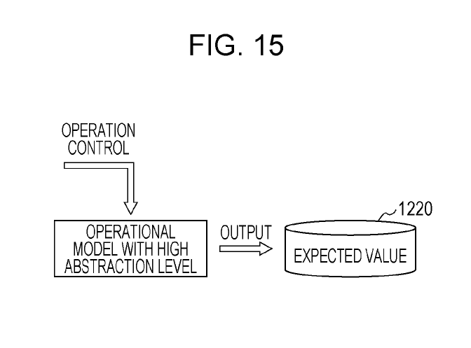

In addition, the first determining unit 1202 determines whether or not a first simulation result obtained by the first operation matches a predetermined result, after the simulation of the first operation by the first operating unit 1201. For example, the predetermined result is an expected value 1220 (as will be illustrated in FIG. 15), and the first determining unit 1202 compares the first simulation result with the expected value 1220 and determines whether or not the first simulation result matches the expected value 1220.

FIG. 15 is a diagram illustrating an example of generation of an expected value, according to a second embodiment. The expected value 1220 may be an operational result of an operational model that has a higher abstraction level than the models 1210 and 1211 to be subjected to the ESL simulation. For example, when the models 1210 and 1211 according to the second embodiment are described using a hardware description language, the operational model that has the high abstraction level may be described using C language or the like.

When the first determining unit 1201 determines that the first simulation result matches the predetermined result, the first operating unit 1201 executes the event-driven ESL simulation on the first operation of the memory mem using a new test pattern and a model.

When the first determining unit 1202 determines that the first simulation result does not match the predetermined result, the second operating unit 1203 executes the event-driven ESL simulation on the second operation of the memory mem using the test pattern and model that have been used by the first operating unit 1201.

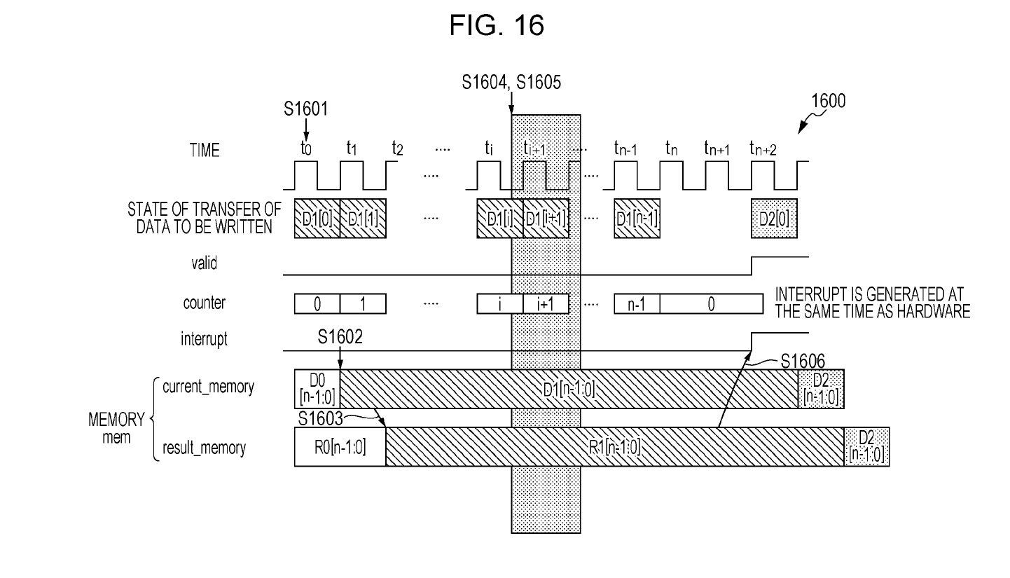

FIG. 16 is a diagram illustrating an example of a second operation, according to a second embodiment. A timing chart 1600 indicates a state in which a request to write data in the memory mem is generated in the event-driven simulation of the second operation of the memory mem and a state in which a request to read data from the memory mem is generated during a writing process in the event-driven simulation of the second operation of the memory mem. In the same manner as the example of the first operation, instead of the clock signal, a valid signal and a counter are provided where the valid signal indicates that data to be processed by a writing process is being received and the counter counts a predetermined time-period during which the data is to be received. The valid signal and the counter may not be used when data is not read out within the predetermined time-period.

The second operating unit 1203 simulates an operation of the memory mem detecting a request to write the second data D1 [n−1:0] in the memory mem when the memory mem has the first data D0 [n−1:0] stored in the buffer current_memory (in step S1601). Then, the second operating unit 1203 simulates an operation of storing the second data D1 [n−1:0] in the buffer current_memory (in step S1602). Thus, the second data D1 [n−1:0] is stored in the buffer current_memory at the time-point t₁.

Next, the second operating unit 1203 simulates an operation of storing, in the storage area result_memory, second result data R1 [n−1:0] determined based on the second data D1 [n−1:0] stored in the buffer current_memory (in step S1603). Thus, the second result data R1 [n−1:0] is stored in the storage area result_memory at the time-point t₂. The second operating unit 1203 simulates an operation of detecting a request to read data from the memory mem within a predetermined time-period after the detection of the write request (in step S1604) and reading the data from the storage area result_memory in accordance with the read request (in step S1605).

Next, the second operating unit 1203 simulates an operation of the memory mem outputting information indicating completion of the write request when a predetermined time-period elapses after the detection of the write request (in step S1606). For example, the second operating unit 1203 simulates the operation of the memory mem outputting the interrupt signal in the same manner as the operation of the actual hardware. More specifically, the second operating unit 1203 simulates the operation of the memory mem changing the value of the interrupt signal from 0 to 1.

The second determining unit 1204 determines whether or not a second simulation result obtained by the second operation matches a predetermined result. The predetermined result is the same as the aforementioned expected value 1220. For example, the second determining unit 1204 compares the second simulation result with the expected value 1220 and thereby determines whether or not the second simulation result matches the expected value 1220. When the second determining unit 1204 determines that the second simulation result matches the predetermined result, the determining unit 1205 determines that there exists a failure occurring at a source of the read request.

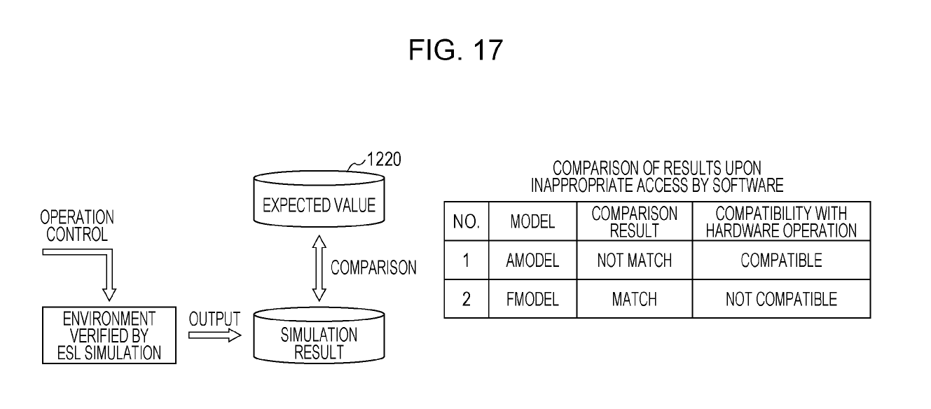

FIG. 17 is a diagram illustrating an example of results of comparison of simulation results with expected values upon generation of a read request, according to a second embodiment. In the example illustrated in FIG. 17, the read request is inappropriately generated within a time-period during which a writing process is being executed in accordance with a write request. In FIG. 17, No. 1 indicates the simulation of the first operation, and No. 2 indicates the simulation of the second operation.

The first simulation result of the first operation of the model described by AMODEL does not match the expected value 1220, and the first operation is compatible with an operation of the hardware. On the other hand, the second simulation result of the second operation of the model described by FMODEL matches the expected value 1220, and the second operation is not compatible with an operation of the hardware.

Based on the above simulation results, when the first simulation result obtained by the first operating unit 1201 does not match the expected value 1220, the first determining unit 1202 is able to determine that a request to read data from the memory mem has been inappropriately generated, for example, by the software or the FW. Further, the second determining unit 1204 is able to determine whether or not only the inappropriate read request has caused the failure, by determining whether or not the second simulation result obtained by the second operating unit 1203 matches the expected value 1220. For example, when the second simulation result matches the expected value 1220, the determining unit 1205 may determine that the failure is caused by the inappropriate read request. When the second simulation result does not match the expected value 1220, the determining unit 1205 may determine that there is a possibility that there exists a cause other than the inappropriate read request.

Thus, the accuracy of identifying the cause of an abnormal read request may be improved. For example, the processes executed by the units 1202 to 1205 are useful for development of the software and the FW.

Example of Process Procedure to be Executed by Simulation Device 1200

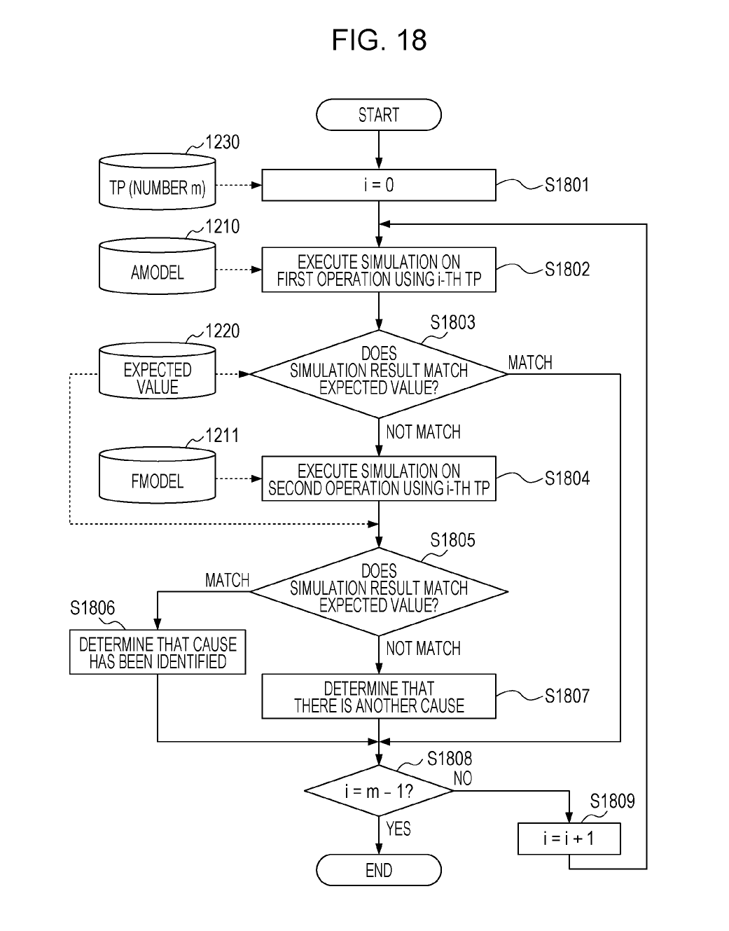

FIG. 18 is a diagram illustrating an example of an operational flowchart performed by a simulation device, according to a second embodiment. The simulation device 1200 sets variable i at 0 (in step S1801) and executes the event-driven simulation on the first operation using the model 1210 and an i-th TP 1230 among the number m of TPs 1230 (in step S1802). The simulation device 1200 determines whether or not a simulation result of the first operation matches the expected value 1220 (in step S1803).

When the simulation result of the first operation matches the expected value 1220 (Match in S1803), the operation proceeds to step S1808. When the simulation result of the first operation does not match the expected value 1220 (Not match in S1803), the simulation device 1200 executes the event-driven simulation on the second operation using the model 1211 and the i-th TP 1230 (in step S1804). The simulation device 1200 determines whether or not a simulation result of the second operation matches the expected value 1220 (in step S1805). When the simulation result of the second operation matches the expected value 1220 (Match in step S1805), the simulation device 1200 determines that the cause has been identified (in step S1806), and the operation proceeds to step S1808. When the simulation result of the second operation does not match the expected value 1220 (Not match in step S1805), the simulation device 1200 determines that there is another cause (in step S1807), and the operation proceeds to step S1808.

When the simulation result of the first operation matches the expected value 1220 (Match in step S1803), or after the operation of step S1806 or S1807, the simulation device 1200 determines whether or not the variable i is equal to a value m−1 (in step S1808). When the variable i is equal to the value of m−1 (Yes in step S1808), the operation is terminated. When the variable i is not equal to the value m−1 (No in step S1808), the simulation device 1200 increments the variable i by 1 (in step S1809), and the operation returns to step S1802.

For reference, description is given of the simulation of an operation of the memory mem using a model described by a description method referred to as LMODEL.

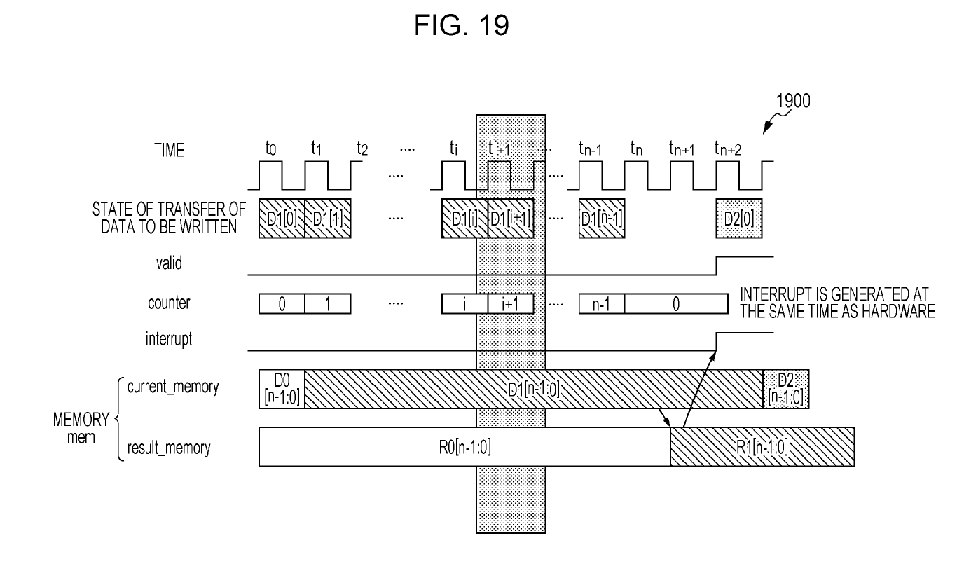

FIG. 19 is a diagram illustrating an example of an operation based on another model. FIG. 19 shows a model, called LMODEL, in which the interrupt signal indicating completion of a writing process is generated at the same timing as hardware. A timing chart 1900 indicates a state in which a request to write data in the memory mem is generated in the event-driven simulation of the operation of the memory mem and a state in which a request to read data from the memory mem is generated during a writing process in the event-driven simulation of the operation of the memory mem. A memory model representing the memory mem described by LMODEL includes the first storage area current_memory and the third storage area result_memory. The operation of the memory mem is simulated by the ESL simulation that executes the memory model.

In the same manner as the first and second operations, instead of the clock signal, a valid signal and a counter are provided where the valid signal indicates that data to be processed by a writing process is being received and the counter counts a predetermined time-period during which the data is to be received. In the example illustrated in FIG. 19, the counter counts numbers from 0 to n−1.

In the simulation of the operation of the memory mem using LMODEL, when a write request is generated at the time-point t₀, the second data D1 [n−1:0] is stored in the buffer current_memory at the time-point t₁ and a value of the counter is counted up. At the time-point t₁, the data R0 [n−1:0] is stored in the storage area result_memory without a change.

When a read request is detected at the time-point tᵢ₊₁, the data R0[n−1:0] stored in the storage area result_memory is read out and transmitted to a source of the read request. Thus, the data that is different from an operation of the actual hardware is read out.

When the value of the counter becomes 0 at the time-point tₙ, the data R1 [n−1:0] determined based on the data D1 [n−1:0] is stored in the storage area result_memory at the time-point tₙ₊₁. At the time-point tₙ₊₂, the interrupt signal indicating completion of the writing process executed in accordance with the write request is issued. As illustrated in FIG. 19, the value of the interrupt signal is changed from 0 to 1. The simulation result of the first operation according to the second embodiment is closer to the operation of the hardware than the simulation result of the operation illustrated in FIG. 19.

As described above, in the simulation of the first operation according to the second embodiment, when a request to write the second data is generated in a state where the first data is being stored in the first storage area, the first data stored in the first storage area is stored in the second storage area. After that, the second data is stored in the first storage area in the simulation of the first operation. Then, in the simulation of the first operation, when the read request is generated within the predetermined time-period after the detection of the write request, result data determined from the collection data including the first and second data complying with a time-point at which the read request is detected is stored in the third storage area. Thus, the event-driven simulation result that is close to a result of the operation of the memory mem of the actual hardware may be obtained.

As for the simulation method and simulation program according to the second embodiment, it is unnecessary to describe an operation between the memory model and a model representing hardware other than the memory, and it is sufficient to add the functions to only the memory model. Further, with the simulation method and simulation program according to the second embodiment, any calculation may be executed before writing in a memory element included in the memory, thereby performing a simulation that is close to an operation of the actual hardware.

The simulation according to the second embodiment allows a time needed for executing the simulation to be reduced, compared with cycle-accurate simulation. For example, it is assumed that it takes a dozen of days to verify an operation of actual hardware. Based on this assumption, in high abstraction level RTL verification, there is a possibility that the operation is not verified in several days depending on the size of a circuit to be simulated. In the event-driven simulation of the model described by the aforementioned FMODEL, it takes several hours, but a failure may not be reproduced. On the other hand, in the event-driven simulation of the model described by the aforementioned AMODEL according to the second embodiment, although it takes several hours, a failure is reproduced. Thus, even if a failure occurs in the actual hardware, the simulation method according to the second embodiment may support early detection of the failure.

The predetermined time-period is set at a time-period that is determined based on the amount of the second data. This allows a request to read data from the memory mem to be detected within a time-period during which a writing process is executed in accordance with a write request.

When a time-period during which a writing process is to be executed elapses, information that indicates completion of the writing process executed in accordance with the write request is output. Thus, an event-driven simulation result may be obtained that is close to a result of a writing operation of the memory mem of the actual hardware.

When the simulation result of the first operation does not matches the expected value, the simulation device 1200 simulates the second operation of the memory model that does not have the second storage area. When the simulation result of the second operation matches the expected value, the simulation device 1200 determines that the operational failure is caused by the source that has generated a request to read the data from the memory mem within the time-period during which the writing process is executed in accordance with the write request. Thus, the cause of the operational failure may be easily identified.

In the simulation of the first operation, in order to store data in the third storage area on the basis of the first and second data, second result data, which is determined based on collection data complying with a deviated time-point that is deviated by a predetermined time from a time-point at which the read request is detected, is stored in the third storage area. Thus, even if there is a difference between a time-point at which a change is made in an operation of the actual hardware and a time-point at which a change is made in the first operation in the ESL simulation, the difference may be adjusted by utilizing plural pieces of collection data.

The simulation method described in the first and second embodiments may be achieved by causing a computer such as a personal computer or a workstation to execute a prepared simulation program. The simulation program is recorded in a computer-readable recording medium, such as a hard disk, a flexible disk, a compact disc-ROM (CD-ROM), a magneto-optical disc (MO), or a digital versatile disc (DVD), and executed by causing the computer to read the simulation program. The simulation program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A simulation method performed by a computer that executes event-driven simulation on an operation of a system including a plurality of hardware elements and an arbitrating circuit for arbitrating transmission of data among the plurality of hardware elements, the simulation method comprising:
simulating a reception operation of the arbitrating circuit receiving a first request for permitting transmission of first data from a source hardware element to a destination hardware element, the source and destination hardware elements being included in the plurality of hardware elements;
saving, in a memory, as backup data, data that has been stored in a storage area of the destination hardware element by the event-driven simulation;
performing a first storing operation of storing the first data in the storage area of the destination hardware element in accordance with the first request;
starting measurement of a first time-period taken to transmit the first data from the source hardware element to the destination hardware element in the system, from a first time-point at which the first data has been stored in the storage area of the destination hardware element;
upon receiving a second request for permitting transmission of second data at a second time-point after receiving the first request, determining whether or not the second request has a higher priority than the first request; and
when it is determined that the second request has a higher priority than the first request, performing a process including:
restoring, from the memory to the storage area of the destination hardware element, a portion of the backup data that is determined based on a second time-period between the first and second time-points so that the storage area stores, out of the first data, third data that is estimated to have been transmitted to the destination hardware element at the second time-point,
measuring, from the second time-point, a second time-period taken to transmit the second data for the second request, and
performing a second storing operation of storing again the first data in the storage area of the destination hardware element for the first request.

2. The simulation method of claim 1, wherein
when it is determined that the second request has a higher priority than the first request, the computer measures, from the second time-point, a third time-period that is a sum of the second time-period and a time-period obtained by subtracting the second time-period from the first time-period.

3. The simulation method of claim 1, wherein
when it is determined that the first request has a higher or equal priority than the second request, the computer saves, in the memory, as backup data, data that has been stored in the storage area of the destination hardware element for the second request by the event-driven simulation.

4. The simulation method of claim 1, wherein
the portion of the backup data to be restored is extracted from the memory, based on a ratio of the second time-period to the first time-period.

5. The simulation method of claim 1, wherein
the portion of the backup data to be restored is extracted from the memory, based on a ratio of the third time-period to the first time-period and a deviation in an amount of the first data.

6. A simulation method performed by a computer that executes event-driven simulation on an operation of a first memory including first, second, and third storage areas, the simulation method comprising performing a first procedure including:
upon detecting, at a first time-point, a first write request to write second data in the first memory in a state of first data being stored in the first storage area, storing the first data in the second storage area and storing the second data in the first storage area,
upon detecting, at a second time-point within a predetermined time-period from the first time-point, a first read request to read out data from the first memory, storing, in the third storage area, first result data that is determined based on data that is included in the first and second data and complies with the second time-point, and
performing a process of reading out the first result data from the third storage area in accordance with the first read request.

7. The simulation method of claim 6, wherein
the first procedure further includes:
causing the first memory to store, in the third storage area, second result data that is determined based on the second data stored in the first storage area when the predetermined time period has elapsed from the first time-point; and
causing the first memory to output information indicating completion of a writing process executed in accordance with the first write request.

8. The simulation method of claim 6, further comprising:
determining whether or not a first simulation result obtained by the first procedure conforms with a predetermined result; and
when it is determined that the first simulation result does not conform with the predetermined result, causing a second memory including the first and third storage area but not including the second storage area to perform a second procedure including:
upon detecting, at a third time-point, the write request to write the second data in the second memory in a state of the first data being stored in the first storage area, storing the second data in the first storage area and storing second result data that is determined based on the second data stored in the first storage area, in the third storage area, and
upon detecting, at a fourth time-point within the predetermined time-period from the third time-point, a second read request to read out data from the second memory, performing a read process of reading out data from the third storage area in accordance with the second read request;
determining whether or not a second simulation result obtained by the second procedure conforms with the predetermined result; and
determining that a source of the second read request is in an abnormal state when the second simulation result conforms with the predetermined result.

9. The simulation method of claim 6, wherein
upon detecting, at the second time-point within the predetermined time-period from the first time-point, the first read request to read out data from the first memory, the first memory stores, in the third storage area, second result data determined based on data that is included in the first and second data and complies with a third time-point that is deviated by a predetermined time from the second time-point, and
the first memory performs a process of reading out the second result data from the third storage area in accordance with the first read request.

10. The simulation method of claim 6, wherein
the predetermined time-period is determined based on an amount of the second data.

11. A computer readable recording medium having stored therein a program for causing a computer to execute a procedure, the computer performing event-driven simulation on an operation of a system including a plurality of hardware elements and an arbitrating circuit for arbitrating transmission of data among the plurality of hardware elements, the procedure comprising:
simulating a reception operation of the arbitrating circuit receiving a first request for permitting transmission of first data from a source hardware element to a destination hardware element, the source and destination hardware elements being included in the plurality of hardware elements;
saving, in a memory, as backup data, data that has been stored in a storage area of the destination hardware element by the event-driven simulation;
performing a first storing operation of storing the first data in the storage area of the destination hardware element in accordance with the first request;
starting measurement of a first time-period taken to transmit the first data from the source hardware element to the destination hardware element in the system, from a first time-point at which the first data has been stored in the storage area of the destination hardware element;
upon receiving a second request for permitting transmission of second data at a second time-point after receiving the first request, determining whether or not the second request has a higher priority than the first request; and
when it is determined that the second request has a higher priority than the first request, performing a process including:
restoring, from the memory to the storage area of the destination hardware element, a portion of the backup data that is determined based on a second time-period between the first and second time-points so that the storage area stores, out of the first data, third data that is estimated to have been transmitted to the destination hardware element at the second time-point,
measuring, from the second time-point, a second time-period taken to transmit the second data for the second request, and
performing a second storing operation of again storing the first data in the storage area of the destination hardware element for the first request.

12. A computer readable recording medium having stored therein a program for causing a computer to execute a procedure, the computer performing event-driven simulation on an operation of a memory including first, second, and third storage areas, the procedure comprising:
upon detecting, at a first time-point, a write request to write second data in the first memory in a state of first data being stored in the first storage area, storing the first data in the second storage area and storing the second data in the first storage area,
upon detecting, at a second time-point within a predetermined time-period from the first time-point, a read request to read out data from the first memory, storing, in the third storage area, first result data that is determined based on data that is included in the first and second data and complies with the second time-point, and
performing a process of reading out the first result data from the third storage area in accordance with the read request.
